(19) United States
(12) Patent Application Publication
(10) Pub. No.: US 2017/0140402 A1
(43) Pub. Date: May 18, 2017

(54) SALES FORECAST DISPLAY METHOD, SALES FORECAST DISPLAY APPARATUS, AND RECORDING MEDIUM

(71) Applicant: FUJITSU LIMITED, Kawasaki-shi (JP)

(72) Inventor: Kunie DOI, Oota (JP)

(21) Appl. No.: 15/335,869

(22) Filed: Oct. 27, 2016

(30) Foreign Application Priority Data
Nov. 16, 2015 (JP) 2015-223901

(51) Int. Cl. G06Q 30/02; G06T 11/20

(52) U.S. Cl. CPC G06Q 30/0202; G06T 11/206; G06F 3/0482

(57) ABSTRACT

A sales forecast display method includes receiving, by a computer, selection of whether to display a simulation result of a sales forecast based on a first trend related to sales calculated based on sales records or a simulation result of a sales forecast based on a second trend related to sales calculated based on the sales records; and displaying, by the computer, not only information indicating the first trend used for calculation of the simulation result of the sales forecast based on the first trend but also information indicating the second trend, when selection of displaying the simulation result of the sales forecast based on the first trend is received.

### CROSS REFERENCE TO RELATED APPLICATIONS

This application is based upon and claims the benefit of priority of the prior Japanese Patent Application No. 2015-223901, filed on Nov. 16, 2015, the entire contents of which are incorporated herein by reference.

### FIELD

The embodiments discussed herein relate to a sales forecast display method, a sales forecast display apparatus, and a recording medium.

### BACKGROUND

In a method called rolling forecast, a budget or earning forecast planned annually is not fixed for a year, but rather the budget or earning forecast is re-evaluated at a shorter span such as semiannually or quarterly, according to developments in the market and economy, the latest sales record, and the like.

Conventional techniques related to the present invention include a technique of forecasting demands of items of which, for example, the number of sales increases at the end of a year and rapidly decreases at the start of the next year. Also, there is a technique using a neural network and is related to a forecast of a quantity of selling items in the future. Further, there is a technique focusing on use of a transition probability distribution function, which performs calculations based on a process of transition of a change, as useful logic for a selling number forecast or production management, and simplifying this function into a practical form.

Further, there is a technique of referring to a production rule and a membership function that are defined by a fuzzy set representing a relation of the magnitude of a past quantity of selling number record and multiple selling-quantity variation degrees, so as to perform a fuzzy operation to quantify the selling-quantity variation degrees and obtain a quantity of forecasted selling numbers in the future. There is a further technique of displaying operation records until the present time and a forecasted simulation result of a plant by an operation guidance on a display screen in a normal state and of displaying, in addition to the above displaying, similar operation record examples retrieved from operation data until the present time on the same display screen simultaneously in an abnormal state, thereby conducting support of plant operations. For examples, refer to Japanese Laid-Open Patent Publication Nos. 2004-334328, H8-221384, H5-314094, H7-175786, and H3-216705.

### SUMMARY

According to an aspect of an embodiment, a sales forecast display method includes receiving, by a computer, selection of whether to display a simulation result of a sales forecast based on a first trend related to sales calculated based on sales records or a simulation result of a sales forecast based on a second trend related to sales calculated based on the sales records; and displaying, by the computer, not only information indicating the first trend used for calculation of the simulation result of the sales forecast based on the first trend but also information indicating the second trend, when selection of displaying the simulation result of the sales forecast based on the first trend is received.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram depicting an example of a sales forecast display method according to an embodiment;

FIG. 2 is an explanatory diagram depicting a system configuration example of a business support system 200;

FIG. 3 is a block diagram of hardware configuration of a sales forecast display apparatus 100;

FIG. 4 is a block diagram of hardware configuration of a client apparatus 201;

FIG. 5 is an explanatory diagram depicting an example of storage contents of an item attribute table 500;

FIG. 6 is an explanatory diagram depicting an example of storage contents of a weekly attribute record DB 240;

FIG. 7 is an explanatory diagram depicting a screen example of a filter-condition screen 700;

FIG. 8 is an explanatory diagram depicting a screen example of a record-simulation-result list screen 800;

FIG. 9 is a block diagram depicting a functional configuration example of the sales forecast display apparatus 100;

FIG. 10 is an explanatory diagram depicting an example of storage contents of a past record table 1000;

FIG. 11 is an explanatory diagram depicting an example of storage contents of a first simulation-result table 1100;

FIG. 12 is an explanatory diagram depicting an example of storage contents of a second simulation-result table 1200;

FIG. 13 is an explanatory diagram depicting a screen example of a record simulation screen (part 1);

FIG. 14 is an explanatory diagram depicting a screen example of a record simulation screen (part 2);

FIG. 15 is an explanatory diagram depicting a screen example of a record simulation screen (part 3);

FIG. 16 is an explanatory diagram depicting a screen example of a record simulation screen (part 4);

FIGS. 17 and 18 are flowcharts depicting procedures of a sales-forecast displaying process of the sales forecast display apparatus 100;

FIG. 19 is a flowchart depicting an example of a specific processing procedure of a record calculation process;

FIG. 20 is a flowchart depicting an example of a specific processing procedure of a first sales forecast process; and

FIG. 21 is a flowchart depicting an example of a specific processing procedure of a second sales forecast process.

### DESCRIPTION OF THE INVENTION

Embodiments of a sales forecast display method, a sales forecast display apparatus, and recording medium will be described in detail with reference to the accompanying drawings.

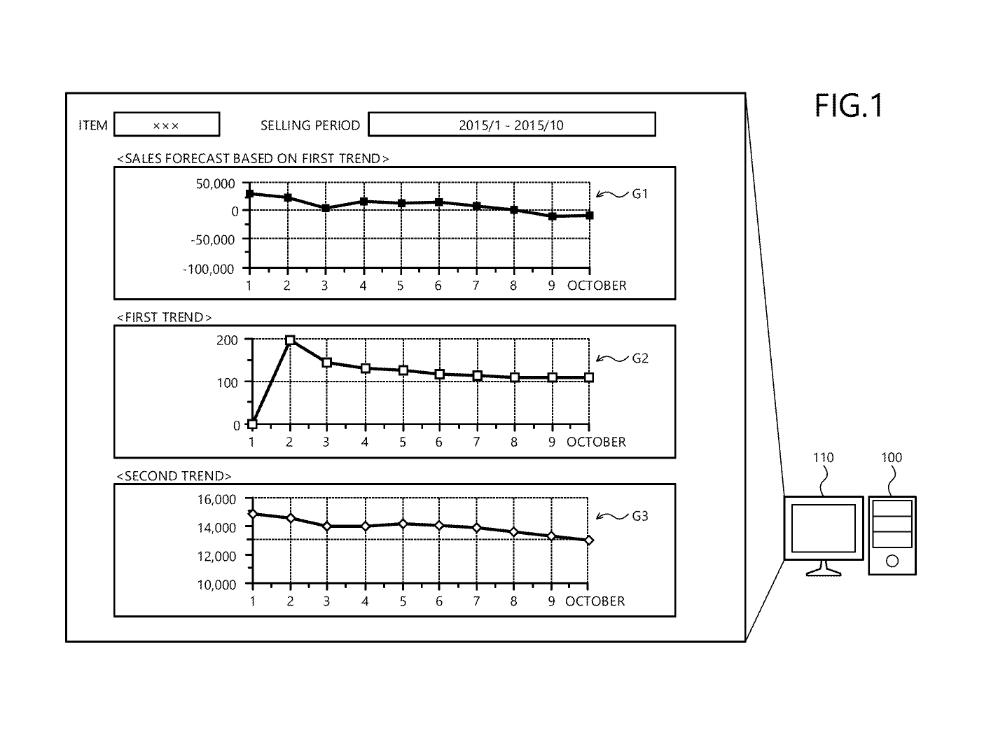

FIG. 1 is an explanatory diagram depicting an example of a sales forecast display method according to an embodiment. In FIG. 1, a sales forecast display apparatus 100 is a computer that displays a simulation result of a sales forecast based on a sales record. The sales record is performance such as sales figures or quantity of sales, which are obtained by selling items or providing services. The sales forecast is a forecast of sales figures, quantity of sales, and the like in the future.

It is important to make a forecast weekly or monthly according to developments in the market and economy, to take measures based on records until the current week or the current month, and to take action according to the forecast. When the forecast is made weekly or monthly, the sales forecast may be made by a user weekly or monthly.

Here, it is conceivable that, by making a sales forecast on a computer, based on sales records and presenting the simulation result thereof to a user, accurate forecasting of sales figures conducted by the user is supported. However, in some cases, it is difficult for the user to determine the suitability of the simulation result only from the presented simulation.

For example, only from the simulation result, the user cannot recognize the basis of the sales forecast and therefore, determination of the suitability of the simulation result is difficult. Further, when only one simulation result is displayed, the user accepts the simulation result without determining its suitability.

Therefore, the present embodiment describes a sales forecast display method of facilitating determination of the suitability of the simulation result of the sales forecast based on sales records to support accurate forecasting of sales figures conducted by a user. A process example of the sales forecast display apparatus 100 is described below.

(1) The sales forecast display apparatus 100 receives a selection of whether a simulation result of a sales forecast based on a first trend or a simulation result of a sales forecast based on a second trend is to be displayed. The first and second trends are trends related to the sales respectively calculated based on sales records.

The first trend is a change rate of sales figures between two consecutive periods among multiple periods included in a certain period in the past, for example. The certain period in the past is a period having a sales record. The multiple periods are periods in the certain period that may be designated in an arbitrary manner. Each period is a period on a daily basis, weekly basis, and monthly basis, for example. The sales figures in each period may be sales figures obtained in that period, or may be cumulative sales figures obtained by cumulating the sales figures obtained from a first one of the multiple periods to that period, for example. The change rate of the sales figures between two consecutive periods represents a trend as to how the sales figures in each period change, and may be used as a basis for forecasting the sales figures in multiple periods in the future.

The second trend is a difference of an average value of the sales figures from the first one of the multiple periods to each period, between the two consecutive periods among the multiple periods included in the certain period in the past, for example. The average value of the sales figures from the first period to each period is an average value of the sales figures respectively obtained by dividing the cumulative sales figures that are a cumulative total of the sales figures from the first period to the each period by an elapsed number of days (a daily average sales figure). The difference of the average value of the daily sales figures between the two consecutive periods represents a trend as to how the sales figures in each period changes and may be used as a basis for forecasting the sales figures in multiple periods in the future.

In this example, a case is assumed where a sales forecast is made in March 2015 to October 2015 with regard to an item “xxx” of which a selling period is “January 2015 to October 2015” at a time when February 2015 has passed. Also, a case is assumed where a sales forecast is made based on the first or second trend calculated based on sales records of a period “January 2014 to October 2014” that is the same time of one year ago with regard to the same item.

(2) The sales forecast display apparatus 100 displays not only information indicating the first trend used for calculation of the simulation result of the sales forecast based on the first trend but also information indicating the second trend, upon reception of a selection of displaying the simulation result of the sales forecast based on the first trend.

The information indicating the first trend may be a graph (for example, a line graph or a bar graph) representing the first trend in time series with regard to each of the multiple periods included in the certain period in the past or a table representing the first trend in time series, for example. Further, the information indicating the second trend may be a graph representing the second trend in time series with regard to each of the multiple periods included in the certain period in the past or a table representing the second trend in time series, for example.

In particular, for example, the sales forecast display apparatus 100 displays a graph G2 and a graph G3 together with a graph G1 on a display 110. In this example, the graph G1 is a line graph representing the simulation result of the sales forecast based on the first trend, and represents monthly sales figures of January 2015 to October 2015 in time series, in a coordinate system formed by a vertical axis representing a sales figure and a horizontal axis representing passage of time.

The graph G2 is a line graph representing the first trend in time series, and represents a change rate of cumulative sales figures between two consecutive months in January 2014 to October 2014, in a coordinate system formed by a vertical axis representing the change rate of the cumulative sales figures and a horizontal axis representing passage of time. The graph G3 is a line graph representing the second trend in time series, and represents a difference of daily average sales figures between the two consecutive months in January 2014 to October 2014, in a coordinate system formed by a vertical axis representing the difference of the daily average sales figures and a horizontal axis representing passage of time. The daily average sales figures in this example are an average value of daily sales figures respectively obtained by dividing a cumulative sales figure obtained by accumulating sales figures from January 1st 2014 to the last day of the month by the elapsed number of days. In particular, for example, the sales forecast display apparatus 100 combines the time axes of the graphs G2 and G3, to display the change rate of the cumulative sales figures and the difference of the daily average sales figures between each month and its previous month in the period from January 2014 to October 2014 in a corresponding manner.

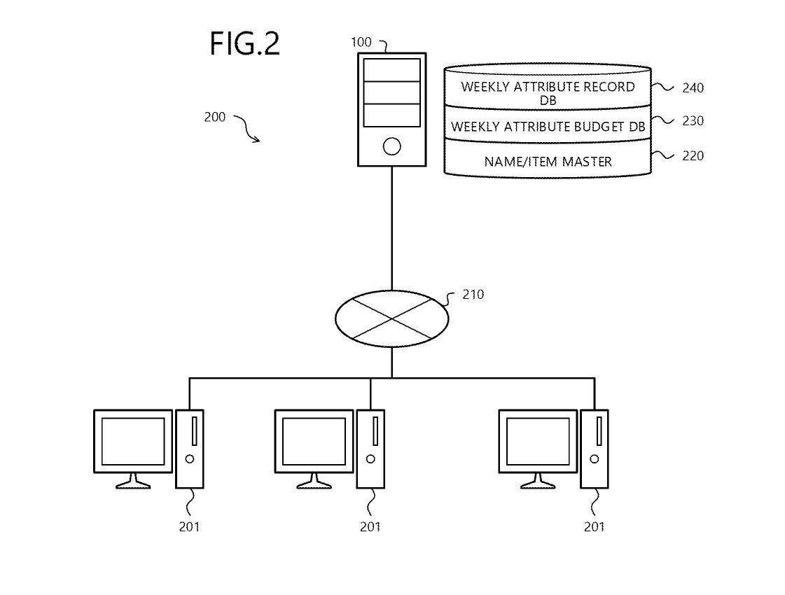

It is also possible that the display 110 is included in the sales forecast display apparatus 100, or included in another computer (for example, a client apparatus 201 depicted in FIG. 2 described later) connected to the sales forecast display apparatus 100 in a communicable manner.

According to the graph G1, a user may recognize sales figures forecasted in September and October in 2015 if the sales trend continues as it is at present. Further, the user may understand that the graph G1 represents the simulation result of the sales forecast based on the first trend and thus, the user can determine the suitability of the simulation result after ascertaining the basis for the sales forecast.

Furthermore, according to the graph G2, the user may confirm a time-series change of the change rate of the cumulative sales figures that are the first trend used as the basis for the sales forecast. As a result, for example, in a case where the graph G2 indicates a drastic variation of the change rate of the cumulative sales figures, the user can determine that the simulation result of the graph G1 is not suitable.

Further, according to the graph G3, the user can confirm a time-series change of the difference of the daily average sales figures that are the second trend used as the basis for the sales forecast. As a result, for example, in a case where the user has determined that the second trend is more suitable as the trend used for the current sales forecast than the first trend, it is possible to display the simulation result of the sales forecast based on the second trend by selecting display of the corresponding simulation result.

In this manner, according to the sales forecast display apparatus 100, even when a selection is made to display the simulation result of the sales forecast based on the first trend among the first and second trends related to the sales calculated based on the sales records, it is possible to display not only the information indicating the first trend but also the information indicating the second trend. Therefore, it is possible to enable the respective contents of the first and second trends, which are the bases of the sales forecast, to be ascertained and to facilitate determination of the suitability of the simulation result.

Next, as an example, a case is described where the sales forecast display apparatus 100 depicted in FIG. 1 is applied to a business support system 200, which is introduced in a company that operates multiple stores selling clothes.

FIG. 2 is an explanatory diagram depicting a system configuration example of the business support system 200. In FIG. 2, the business support system 200 includes the sales forecast display apparatus 100 and multiple client apparatuses 201. In the business support system 200, the sales forecast display apparatus 100 and the client apparatuses 210 are connected to each other via a wired or wireless network 210. The network 210 is, for example, a local area network (LAN), a wide area network (WAN), or the Internet.

In this example, the sales forecast display apparatus 100 includes a name/item master 220, a weekly attribute budget database (DB) 230, and a weekly attribute record DB 240, and executes control of displaying a simulation result of a sales forecast based on sales records. The sales forecast display apparatus 100 is a server, for example.

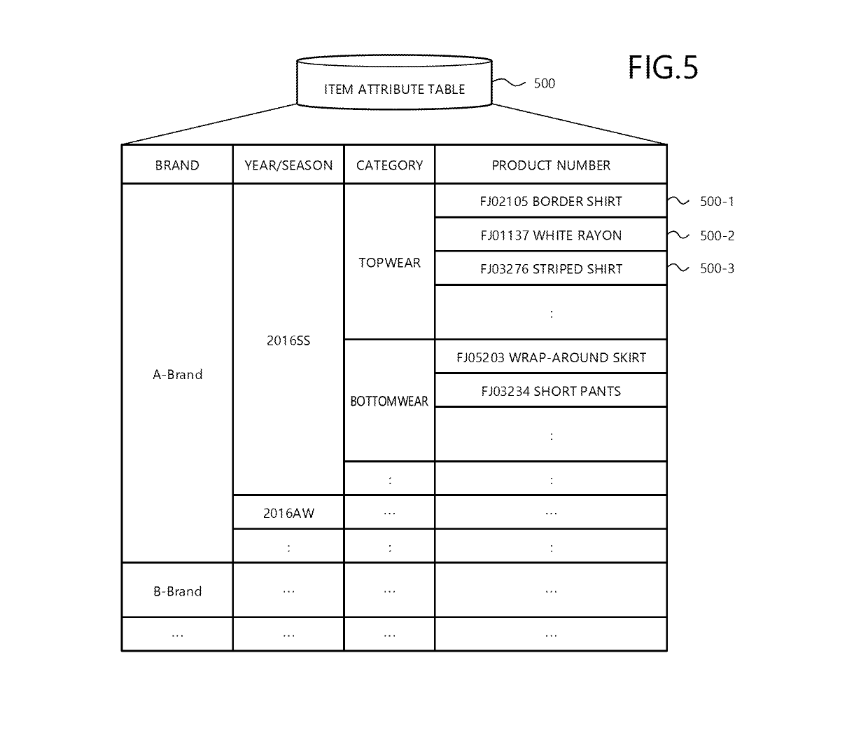

The name/item master 220 stores therein information related to stores and information related to items sold at the stores. The items include clothes, underwear, shoes, and bags, for example. For example, each of the items is managed with a product number uniquely identifying each item. The name/item master 220 includes, for example, an item attribute table 500 depicted in FIG. 5 described later.

The weekly attribute budget DB 230 stores therein weekly sales estimates and weekly gross profit estimates with regard to each item attribute. The item attribute is an attribute that characterizes an item. The item attribute is described in detail later with reference to FIG. 5. The sales estimate is an estimated sales figure. The gross profit estimate is an estimated gross profit.

Configuration may be such that the weekly attribute budget DB 230 stores therein daily or monthly sales estimates and daily or monthly gross profit estimates. Further, configuration may be such that the weekly attribute budget DB 230 stores therein weekly (or daily or monthly) sales estimates and weekly (or daily or monthly) gross profit estimates with regard to each store.

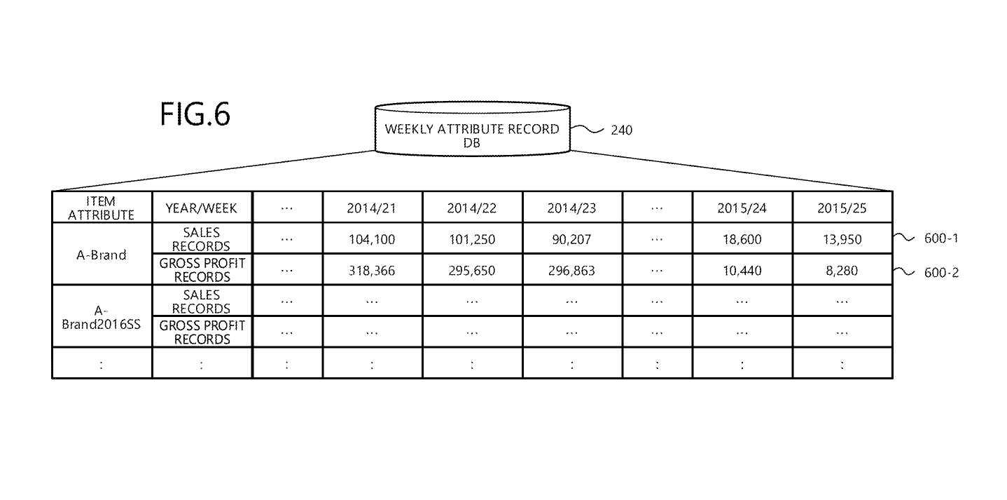

The weekly attribute record DB 240 stores therein weekly sales records and weekly gross profit records with regard to each item attribute. The sales record is a sales figure actually obtained. The gross profit record is a gross profit actually obtained. The storage contents of the weekly attribute record DB 240 are described later with reference to FIG. 6.

Configuration may be such that the weekly attribute record DB 240 stores therein daily or monthly sales records and daily or monthly gross profit records. Further, configuration may be such that the weekly attribute record DB 240 stores therein weekly (or daily or monthly) sales records and weekly (or daily or monthly) gross profit records with regard to each store.

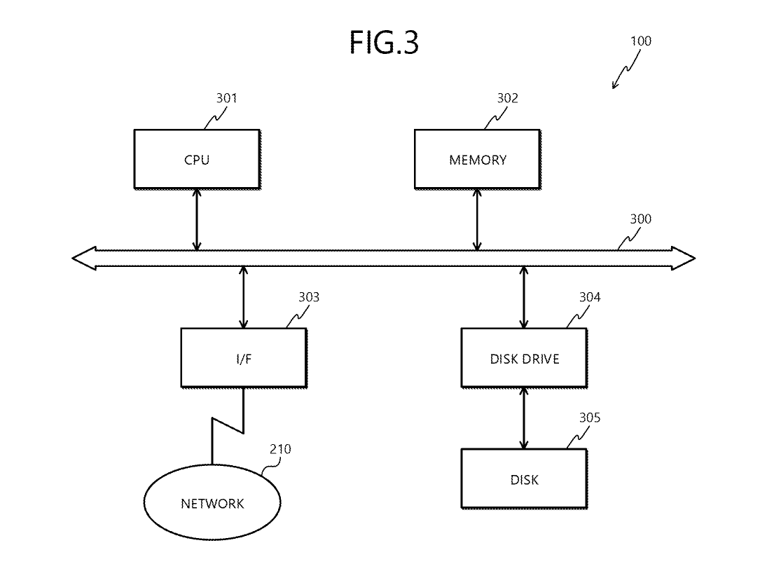

For example, the various DBs 220, 230, and 240 are stored in a storage apparatus of the sales forecast display apparatus 100 depicted in FIG. 3 described later, such as a memory 302 or a disk 305. The data stored in the various DBs 220, 230, and 240 may be registered manually, for example, or may be registered by other systems that manage sales figures, gross profits, and the like of each item at each store.

The client apparatus 201 is a computer such as a personal computer (PC), a tablet terminal, or a smartphone. For example, the client apparatus 201 is used by a user who makes a weekly or monthly forecast to re-evaluate a budget and plans operations such as inter-store transfer and changing selling prices.

In the business support system 200, upon reception of a request for displaying various screens from the client apparatus 201, for example, the sales forecast display apparatus 100 creates screen information of various screens and transmits the created information to the client apparatus 201. Thus, the client apparatus 201 may display the various screens.

FIG. 3 is a block diagram of hardware configuration of the sales forecast display apparatus 100. In FIG. 3, the sales forecast display apparatus 100 has a central processing unit (CPU 301), the memory 302, an interface (I/F) 303, the disk drive 304, and the disk 305, respectively connected by a bus 300.

Here, the CPU 301 governs overall control of the sales forecast display apparatus 100. The memory 302, for example, includes a read-only memory (ROM), a random access memory (RAM), and a flash ROM. In particular, for example, the flash ROM and the ROM store therein various types of programs, and the RAM is used as a work area of the CPU 301. A program stored in the memory 302 is loaded onto the CPU 301, whereby a coded process is executed by the CPU 301.

The I/F 303 is connected to the network 210 through a communications line and is connected to other apparatuses (e.g., the client apparatuses 201 depicted in FIG. 2) via the network 210. The I/F 303 administers an internal interface with the network 210, and controls the input and output of data from other apparatuses. The I/F 303, for example, may be a modem, a LAN adapter, etc.

The disk drive 304, under the control of the CPU 301, controls the reading and writing of information with respect to the disk 305. The disk 305 stores data written thereto under the control of the disk drive 304. The disk 305, for example, may be a magnetic disk, an optical disk, etc.

The various DBs 220, 230, and 240 depicted in FIG. 2, for example, are realized by a storage apparatus such as the memory 302, the disk 305, etc. Further, in addition to the configuration above, the sales forecast display apparatus 100 may include, for example, a solid state drive, a keyboard, a mouse, a display, etc.

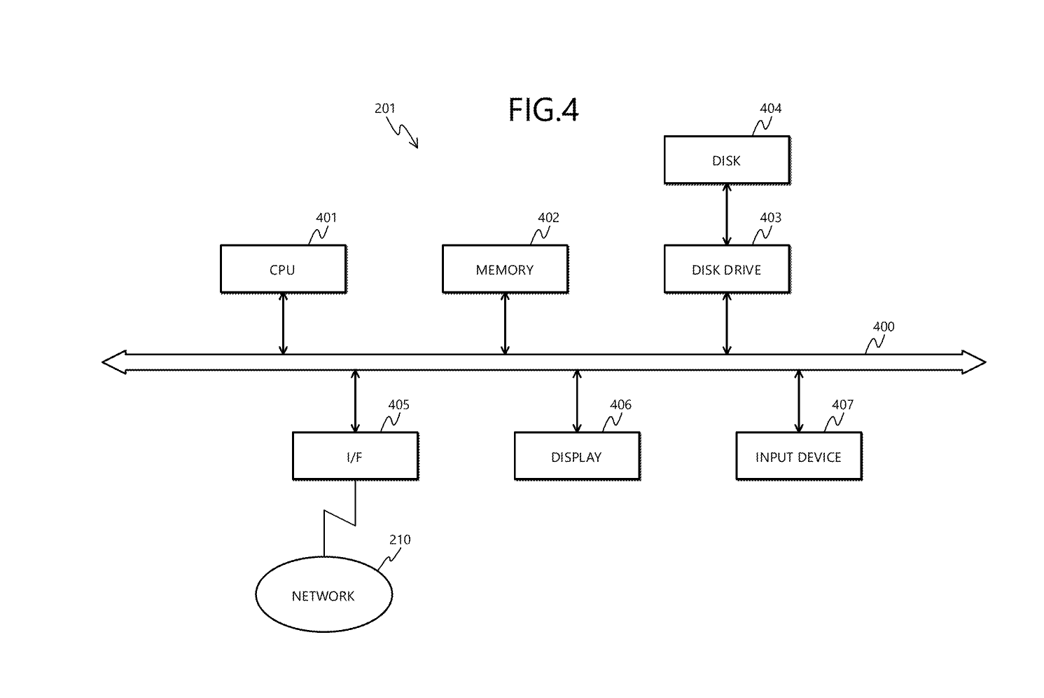

FIG. 4 is a block diagram of hardware configuration of a client apparatus 201. In FIG. 4, the client apparatus 201 has a CPU 401, a memory 402, a disk drive 403, a disk 404, an I/F 405, a display 406, and an input device 407, respectively connected by a bus 400.

Here, the CPU 401 governs overall control of the client apparatus 201. The memory 402, for example, includes a ROM, a RAM, and a flash ROM. In particular, for example, the flash ROM and the ROM store therein various types of programs, and the RAM is used as a work area of the CPU 401. A program stored in the memory 402 is loaded on the CPU 401, whereby a coded program is executed by the CPU 401.

The disk drive 403, under the control of the CPU 401, controls the reading and writing of data with respect to the disk 404. The disk 404 stores data written thereto under the control of the disk drive 403. The disk 404 is, for example, a magnetic disk, an optical disk, etc.

The I/F 405 is connected to the network 210 through a communications line and is connected to other apparatuses (e.g., the sales forecast display apparatus 100 depicted in FIG. 2) via the network 210. The I/F 405 administers an internal interface with the network 210, and controls the input and output of data from other apparatuses.

The display 406 displays data such as documents, images, and functional information, in addition to a cursor, icons, and toolboxes. The display 406, for example, may be a liquid crystal display, a cathode ray tube (CRT), etc.

The input device 407 has keys for inputting characters, numerals, various instructions, etc. and performs data input. The input device 407 may be a keyboard or a mouse, or a touch panel input pad or a numeric pad. The client apparatus 201, for example, may omit the disk drive 403, the disk 404.

Next, the storage contents of the item attribute table 500 included in the sales forecast display apparatus 100 are described. As described above, the item attribute table 500 is included, for example, in the name/item master 220 depicted in FIG. 2.

FIG. 5 is an explanatory diagram depicting an example of storage contents of the item attribute table 500. In FIG. 5, the item attribute table 500 includes fields of brand, year/season, category, and product number. By setting information in each field, item attribute information (for example, item attribute information 500-1 to 500-3) is stored as a record.

In this example, the brand is a name of a brand. The year/season is a season name indicating which year and which season a certain item is targeted for. Examples of the year/season include 2016SS (Spring/Summer) and 2016AW (Autumn/Winter).

The category is a classification of items. The types of the category include, for example, topwear, bottomwear, one-piece dress, and shoes. The product number is an identifier for uniquely identifying the items. Each of the brand, year/season, category, and product number is one of item attributes characterizing the items.

Next, the storage contents of the weekly attribute record DB 240 included in the sales forecast display apparatus 100 are described.

FIG. 6 is an explanatory diagram depicting an example of storage contents of the weekly attribute record DB 240. In FIG. 6, the weekly attribute record DB 240 stores therein weekly attribute record information (weekly attribute record information 600-1, 600-2) indicating weekly sales records and weekly gross profit records with regard to each item attribute.

The weekly attribute record information 600-1 indicates weekly sales records (unit: Yen) and weekly gross profit records (unit: Yen) with regard to items of an item attribute “A-Brand”. The items of the item attribute “A-Brand” are all items of a brand “A-Brand” (see FIG. 5, for example).

The weekly attribute record information 600-2 indicates weekly sales records and weekly gross profit records with regard to items of an item attribute “A-Brand 2016SS”. The items of the item attribute “A-Brand 2016SS” are all items of the brand “A-Brand” in a year/season “2016SS” (see FIG. 5, for example).

Next, a screen example of a filter-condition screen 700 displayed on the display 406 of the client apparatus 201 is described. In the following descriptions, as an example, a case is described where a click operation using the input device 407 depicted in FIG. 4 is performed as an operation by a user for selecting a box, a button, or the like on various screens displayed on the display 406.

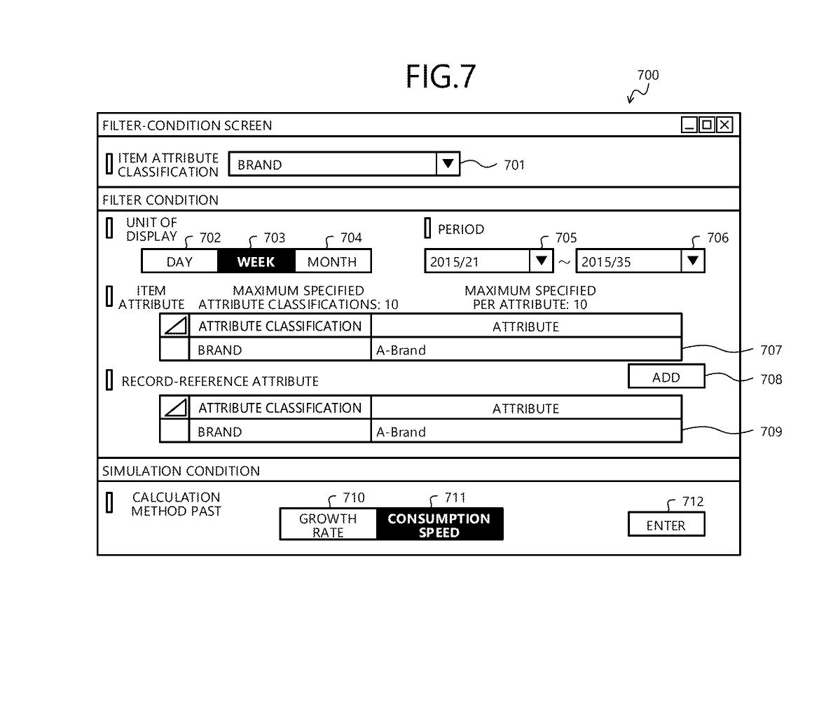

FIG. 7 is an explanatory diagram depicting a screen example of the filter-condition screen 700. In FIG. 7, the filter-condition screen 700 is an operation screen for inputting a filter condition. The filter condition is a condition for narrowing down an item attribute that is an object of a sales forecast, and includes designation of a period as an object of the sales forecast, a record-reference attribute and a calculation method that are used for the sales forecast, and the like.

In the filter-condition screen 700, by clicking a button 701, it is possible to select an item attribute classification that is the object of the sales forecast. Selectable item attribute classifications are brand, year/season, category, and product number, for example. A combination of two or more item attribute classifications (for example, brand and year/season) may be also selected. In the example of FIG. 7, the item attribute classification “brand” is selected.

In the filter-condition screen 700, by clicking any one of buttons 702 to 704, it is possible to designate which one of a day, a week, and a month is used as a display unit for displaying sales figures. Further, by clicking a button 705 or 706, it is possible to designate a period for which sales figures are displayed. In the example of FIG. 7, “week” is designated as the display unit, and a period “2015/21 (21st week of 2015) to 2015/35 (35th week of 2015)” is designated.

In the filter-condition screen 700, by clicking a box 707, the item attribute as the object of the sales forecast may be selected from item attributes corresponding to the selected item attribute classification. In the example of FIG. 7, an item attribute “A-Brand” is selected. By clicking a button 708, it is possible to add the item attribute as the object of the sales forecast.

In the filter-condition screen 700, by clicking a box 709, it is possible to select for which item attribute a sales forecast is made based on sales records. In the example of FIG. 7, a record-reference attribute “A-Brand” is selected.

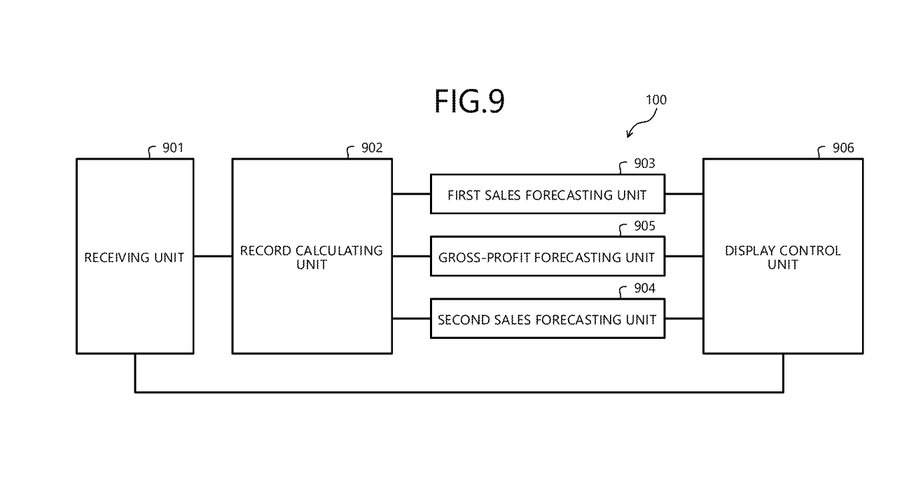

In the filter-condition screen 700, by clicking either one of buttons 710 and 711, it is possible to select which of calculation methods “growth rate” and “consumption speed” is used for the sales forecast. In the example of FIG. 7, the calculation method “consumption speed” is selected. The calculation methods “growth rate” and “consumption speed” are described later with reference to FIG. 9.

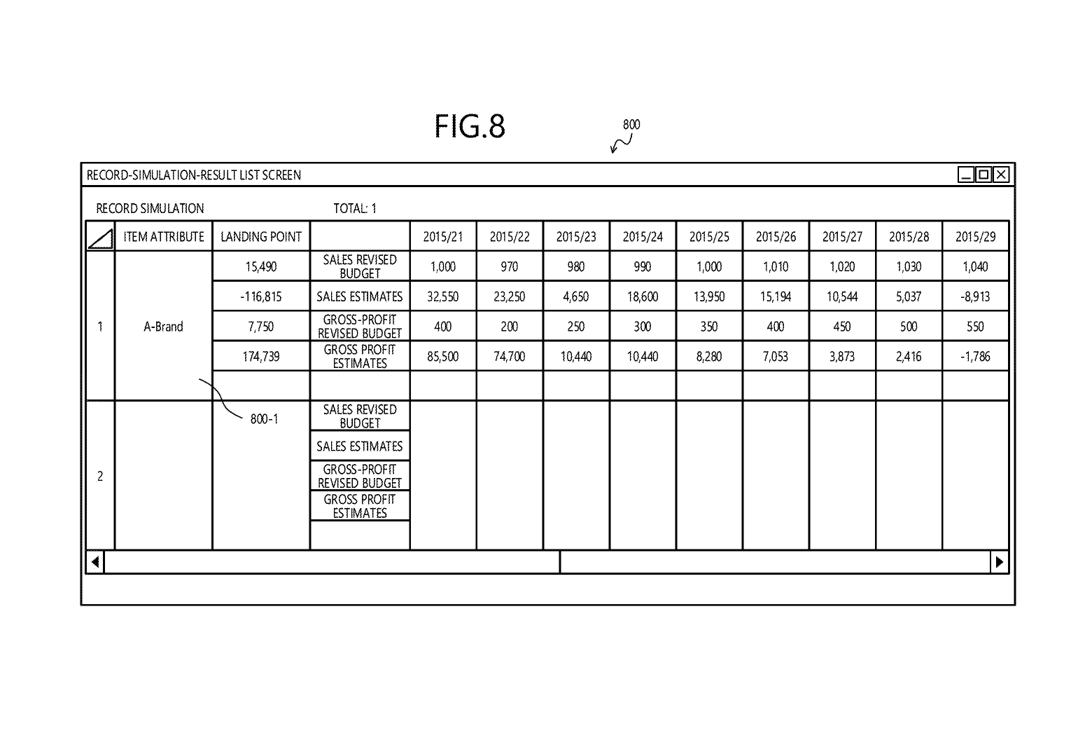

Further, in the filter-condition screen 700, by clicking a button 712, the input filter condition is transmitted from the client apparatus 201 to the sales forecast display apparatus 100, so that a record-simulation-result list screen 800 depicted in FIG. 8 is displayed, for example. In the example of FIG. 7, the filter condition is transmitted, which includes the display unit “week”, the period “2015/21 to 2015/35”, the item attribute “A-Brand”, the record-reference attribute “A-Brand”, and the calculation method “consumption speed”.

Next, a screen example of the record-simulation-result list screen 800 displayed on the display 406 of the client apparatus 201 is described.

FIG. 8 is an explanatory diagram depicting a screen example of the record-simulation-result list screen 800. In FIG. 8, the record-simulation-result list screen 800 is a screen showing the simulation result of the sales forecast with regard to the item attribute selected as the object of the sales forecast in the filter-condition screen 700 (see FIG. 7) in a list.

In this example, the item attribute selected as the object of the sales forecast is “A-Brand” only. Therefore, only a simulation result 800-1 of the sales forecast for the item attribute “A-Brand” is displayed. The simulation result 800-1 represents a sales revised budget, a sales estimate, a gross-profit revised budget, and a gross-profit for each week in the period designated in the filter-condition screen 700 (see FIG. 7).

The sales revised budget is a target sales figure. The sales estimate is an estimated sales figure. The gross-profit revised budget is a target gross profit. The gross profit estimate is an estimated gross profit. Further, a landing point represents a sales revised budget, a sales estimate, a gross-profit revised budget, and a gross profit estimate at a time when the period designated in the filter-condition screen 700 (see FIG. 7) has passed.

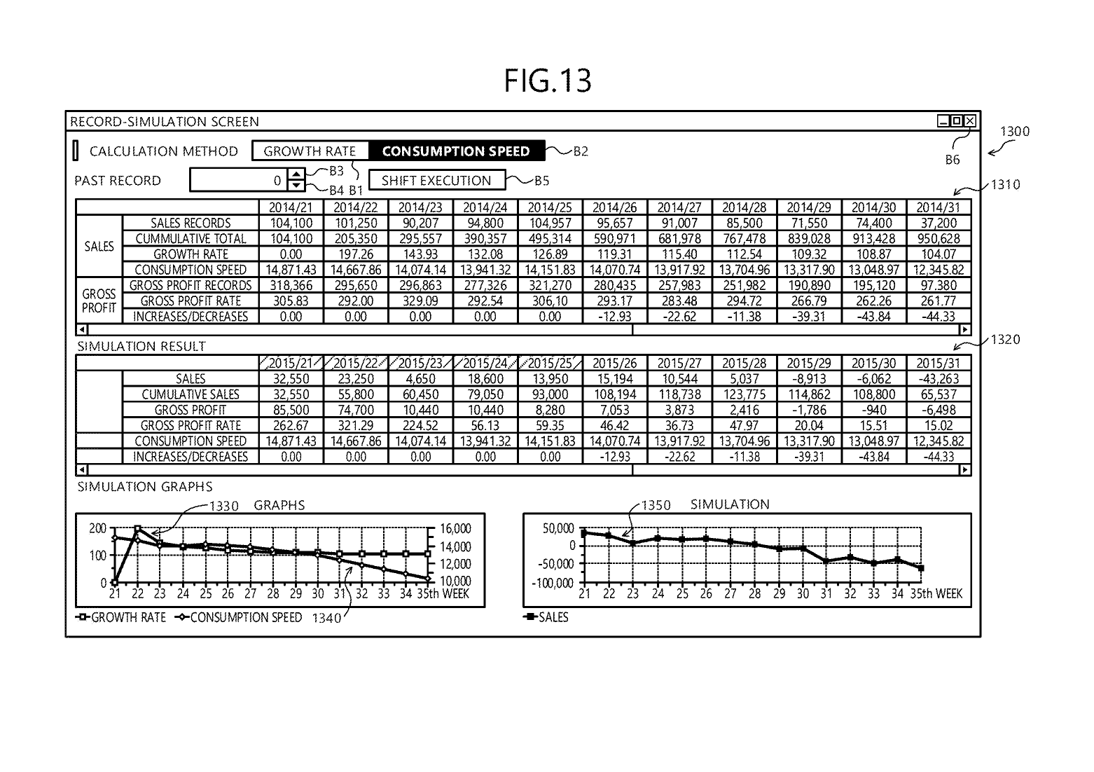

In the record-simulation-result list screen 800, by clicking any of item attributes, a record-simulation screen may be displayed, in which a calculation method used for a sales forecast with regard to the item attribute in question may be switched. A specific example of the record-simulation screen is described with reference to FIGS. 13 to 16.

In a case where only one the item attribute is selected as the object of the sales forecast in the filter-condition screen 700 (see FIG. 7), the sales forecast display apparatus 100 may display the record-simulation screen without displaying the record-simulation-result list screen 800.

FIG. 9 is a block diagram depicting a functional configuration example of the sales forecast display apparatus 100. In FIG. 9, the sales forecast display apparatus 100 is configured to include a receiving unit 901, a record calculating unit 902, a first sales forecasting unit 903, a second sales forecasting unit 904, a gross-profit forecasting unit 905, and a display control unit 906. The receiving unit 901, the record calculating unit 902, the first sales forecasting unit 903, the second sales forecasting unit 904, the gross-profit forecasting unit 905, and the display control unit 906 are functions forming a control unit, and are realized by executing a program stored in a storage apparatus such as the memory 302 or the disk 305 depicted in FIG. 3 on the CPU 301, or by the I/F 303, for example. Processing results of the respective functional units are stored to a storage apparatus such as the memory 302 or the disk 305, for example.

The receiving unit 901 receives an input of a filter condition. The filter condition is a condition for narrowing down a period and an item attribute for which a sales forecast is performed, a record-reference attribute and a calculation method that are used for the sales forecast, and the like. Further, the filter condition is input in the filter-condition screen 700 (see FIG. 7) displayed on the display 406 of the client apparatus 201, for example.

In particular, for example, the receiving unit 901 receives the input of the filter condition by receiving the filter condition from the client apparatus 201. In the example of FIG. 7, the receiving unit 901 receives an input of a filter condition including a display unit “week”, a period “2015/15 to 2015/35”, an item attribute “A-Brand”, a record-reference attribute “A-Brand”, and a calculation method “consumption speed”.

The record calculating unit 902 calculates a growth rate in each partial period included in a record period. In this example, the record period is a past period of the same time of a designated period. The designated period is specified from the display unit and the period included in the filter condition. In a case where the display unit is “week” and the period is “2015/21 to 2015/35”, for example, the designated period is a period from the 21st week of 2015 to the 35th week of 2015.

In this case, the record period is a period from the 21st week to 35th week of a year before 2015. In the following descriptions, the record period is assumed to be the same time of the previous year of the designated period. That is, in a case where the designated period is “2015/21 to 2015/35”, the record period is “2014/21 to 2014/35”.

Each partial period included in the record period is a period corresponding to the display unit included in the filter condition. In a case where the display unit is “week”, for example, the partial period included in the record period is a week included in the record period. Further, in a case where the display unit is “month”, for example, the partial period included in the record period is a month included in the record period. In the following descriptions, a case where the partial period is “week” is described as an example.

The record calculating unit 902 refers to the weekly attribute record DB 240 (see FIG. 6, for example) and acquires weekly sales records and weekly gross profit records in the record period with regard to the record-reference attribute included in the filter condition, for example. It is assumed that the record period is “2014/21 to 2014/35” and the record-reference attribute is “A-Brand”, for example.

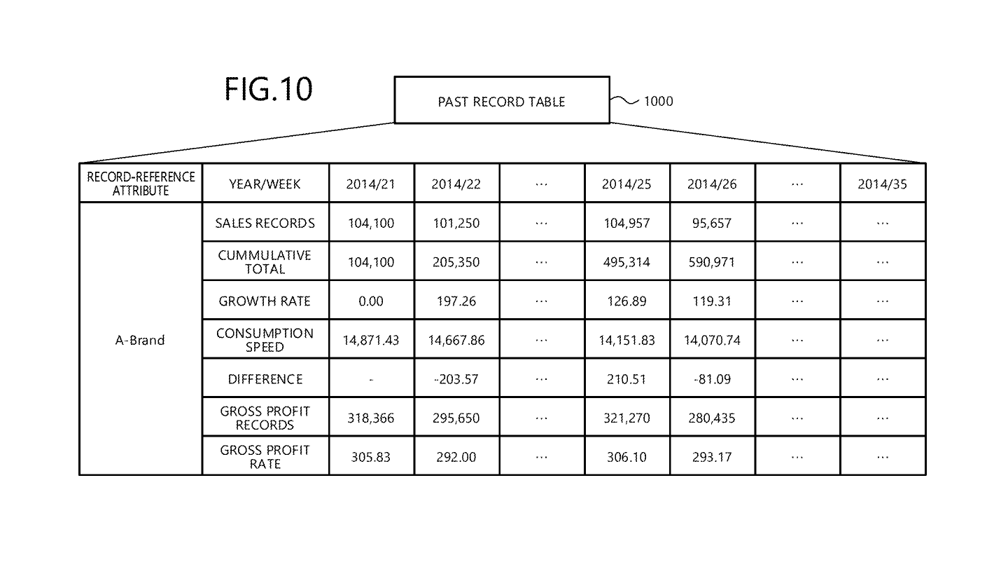

In this case, the record calculating unit 902 refers to the weekly attribute record DB 240 and acquires weekly sales records and weekly gross profit records in the record period “2014/21 to 2014/35” with regard to the record-reference attribute “A-Brand”. The weekly sales records and the weekly gross profit records that have been acquired are stored in a past record table 1000 depicted in FIG. 10, for example.

The storage contents of the past record table 1000 are described here. The past record table 1000 is implemented by a storage apparatus such as the memory 302 or the disk 305 depicted in FIG. 3, for example.

FIG. 10 is an explanatory diagram depicting an example of storage contents of the past record table 1000. In FIG. 10, the weekly sales records (unit: Yen) and the weekly gross profit records (unit: Yen) in the record period “2014/21 to 2014/35” with regard to the record-reference attribute “A-Brand” are stored in the past record table 1000.

Next, the record calculating unit 902 refers to the past record table 1000 and calculates weekly cumulative sales records (unit: Yen) in the record period “2014/21 to 2014/35”. The cumulative sales record is a total of weekly sales records from a first week in the record period to a corresponding week. The calculated weekly cumulative sales records are stored in the past record table 1000 (“CUMULATIVE TOTAL” in FIG. 10), for example.

The record calculating unit 902 refers to the past record table 1000 and calculates weekly growth rates in the record period “2014/21 to 2014/35”. The growth rate in this example is a change rate of cumulative sales figures between two consecutive weeks in the record period.

The record calculating unit 902 may calculate the weekly growth rates of the record period “2014/21 to 2014/35” by using equation (1). In equation (1), an object period is a week (a partial period) for which the growth rate is calculated, and a previous period is a previous week of the object period.

Growth rate in object period=cumulative sales figure in object period cumulative sales figure in previous period×100 (1)

For example, it is assumed that the object period is “2014/22”, and the previous period is “2014/21”. In this case, the record calculating unit 902 divides a cumulative sales figure “205,350” in the object period “2014/22” by a cumulative sales figure “104,100” in the previous period “2014/21” and then multiplies the quotient by 100. In this manner, the record calculating unit 902 obtains a growth rate “197.26” in the object period “2014/22” (the third place after decimal point is rounded off). The obtained weekly growth rates are stored in the past record table 1000 (“GROWTH RATE” in FIG. 10), for example.

Furthermore, the record calculating unit 902 calculates a consumption speed for each week (each partial period) in the record period. The consumption speed in this example is the average value of the daily sales figures from a first week (partial period) in the record period to the object period. The object period is a week (partial period) for which the consumption speed is calculated.

Specifically, the record calculating unit 902 can refer to the past record table 1000 and calculate the weekly consumption speeds in the record period “2014/21 to 2014/35” by using equation (2). In equation (2), the elapsed number of days is the number of days from the first day in the record period to the last day in the object period.

Consumption speed in object period=cumulative sales figure in object period elapsed number of days (2)

For example, when the object period is assumed to be “2014/22”, a cumulative sales figure in the object period “2014/22” is “205,350” and the elapsed number of days is “14”. In this case, the record calculating unit 902 divides the cumulative sales figure “205,350” by the elapsed number of days “14”, to obtain a consumption speed “14,667.86” in the object period “2014/22” (the third place after decimal point is rounded off). The obtained weekly consumption speeds are stored in the past record table 1000, for example.

The record calculating unit 902 also calculates a difference of the consumption speed between two consecutive weeks (partial periods) in the record period. In particular, for example, the record calculating unit 902 refers to the past record table 1000 and calculates the difference of the consumption speed in the object period by subtracting the consumption speed in the previous period from the consumption speed in the object period.

For example, it is assumed that the object period is “2014/22”, a consumption speed in the object period “2014/22” is “14,667.86” and a consumption speed in the previous period “2014/21” is “14,871.43”. In this case, the record calculating unit 902 subtracts the consumption speed “14,871.43” from the consumption speed “14,667.86”, to obtain the difference of the consumption speed “−203.57” in the object period “2014/22”. The obtained differences between the weekly consumption speeds are stored in the past record table 1000 (“DIFFERENCE” in FIG. 10), for example.

The record calculating unit 902 may calculate a change rate of the consumption speed between the two consecutive weeks (partial periods) in the record period, in place of the difference of the consumption speed. Specifically, the record calculating unit 902 refers to the past record table 1000, and calculates the change rate of the consumption speed in the object period by dividing the consumption speed in the object period by the consumption speed in the previous period, for example.

The record calculating unit 902 may calculate a gross profit rate for each week (each partial period) in the record period. The gross profit rate described here is a rate of a gross profit with respect to sales figures. Specifically, the record calculating unit 902 can refer to the past record table 1000 and calculate the weekly gross profit rates in the record period “2014/21 to 2014/35” by using equation (3). In equation (3), the object period is a week (a partial period) for which the gross profit rate is calculated.

Gross profit rate in object period=gross profit in object period sales figure in object period×100 (3)

For example, when the object period is assumed to be “2014/22”, a sales record of the object period is “101,250” and a gross profit record is “295,650”. In this case, the record calculation unit 902 divides the gross profit record “295,650” by the sales record “101,250” and multiplies the quotient by 100, to obtain a gross profit rate “292.00” in the object period “2014/22” (the third place after decimal point is rounded off). The obtained weekly gross profit rates are stored in the past record table 1000, for example.

The first sales forecasting unit 903 calculates forecasted weekly sales figures of an operation week and subsequent weeks thereof for the designated period based on the weekly growth rates in the record period. The operation week described here is a week including the current day and is a week for which a sales record is not fixed at the current moment. The forecasted sales figure is a sales figure that is forecasted. In the following descriptions, the operation week may be described as the “n-th week” (n: natural number).

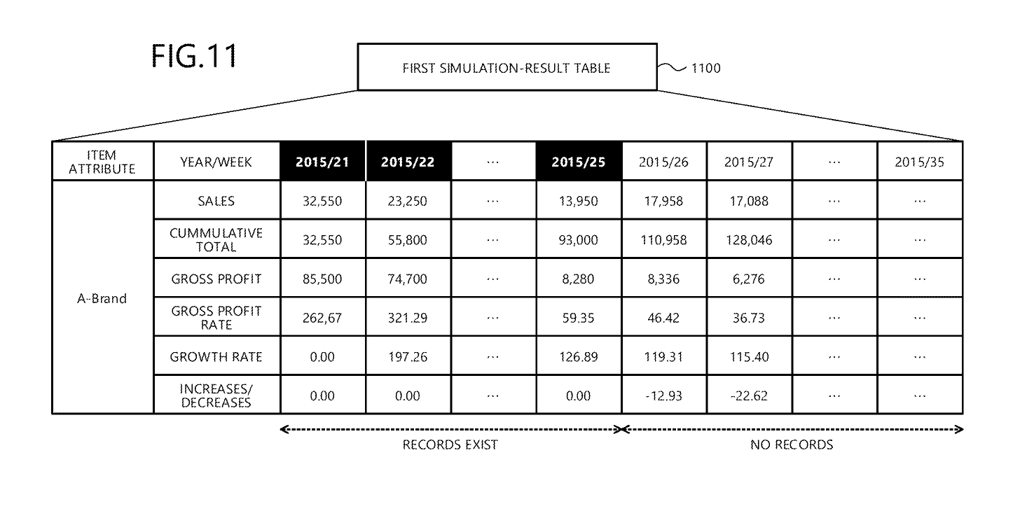

The first sales forecasting unit 903 refers to the past record table 1000 and specifies the weekly growth rates in the record period “2014/21 to 2014/35”, for example. The specified weekly growth rates in the record period “2014/21 to 2014/35” are stored as weekly growth rates for the designated period “2015/21 to 2015/35” in a first simulation-result table 1100 depicted in FIG. 11.

The storage contents of the first simulation-result table 1100 are described here. The first simulation-result table 1100 is implemented by a storage apparatus such as the memory 302 or the disk 305 depicted in FIG. 3, for example.

FIG. 11 is an explanatory diagram depicting an example of storage contents of the first simulation-result table 1100. In FIG. 11, the weekly growth rates (unit: %) for the designated period “2015/21 to 2015/35” with regard to the item attribute “A-Brand” are stored in the first simulation-result table 1100.

Next, the first sales forecasting unit 903 refers to the weekly attribute record DB 240 and acquires weekly sales records up to the previous week of the operation week for the designated period “2015/21 to 2015/35” with regard to the item attribute “A-Brand”. For example, when the operation week is assumed to be “2015/26”, weekly sales records in “2015/21 to 2015/25” are acquired.

At this time, the first sales forecasting unit 903 may further acquire weekly gross profit records in “2015/21 to 2015/25”. The acquired weekly sales records and the weekly gross profit records up to the previous week of the operation week are stored in the first simulation-result table 1100, for example.

Subsequently, the first sales forecasting unit 903 refers to the first simulation-result table 1100 and calculates weekly cumulative sales records up to the previous week of the operation week. The calculated weekly cumulative sales records up to the previous week of the operation week are stored in the first simulation-result table 1100 (“CUMULATIVE TOTAL” in FIG. 11), for example.

The first sales forecasting unit 903 then multiplies a cumulative sales record “93,000” of the previous week of the operation week and a growth rate “119.31” of the operation week and divides the product by 100, to obtain a forecasted-cumulative sales figure “110,958” of the operation week (the first place after decimal point is rounded off), for example. Also, the first sales forecasting unit 903 subtracts the cumulative sales record “93,000” of the previous week from the forecasted-cumulative sales figure “110,958” of the operation week, to obtain a forecasted sales figure “17,958” of the operation week.

In this manner, it is possible to forecast the forecasted-cumulative sales figure “110,958” and the forecasted sales figure “17,958” of the operation week “2015/26”.

Further, the first sales forecasting unit 903 multiplies the forecasted-cumulative sales figure “110,958” of the operation week and a growth rate “115.40” of the next week of the operation week and divides the product by 100, to obtain a forecasted-cumulative sales figure “128,046” of the next week (the first place after place after decimal point is rounded off), for example. Also, the first sales forecasting unit 903 subtracts the forecasted-cumulative sales figure “110,958” of the operation week (the previous week) from the forecasted-cumulative sales figure “128,046” of the next week, to obtain a forecasted sales figure “17,088” of the next week.

In this manner, it is possible to forecast the forecasted-cumulative sales figure “128,046” and the forecasted sales figure “17,088” of the next week “2015/27”. Also, by calculating the forecasted-cumulative sales figures and the forecasted sales figures in a similar manner for the 28th week and subsequent weeks thereof for the designated period “2015/21 to 2015/35”, it is possible to forecast the forecasted weekly-cumulative sales figures and the forecasted weekly sales figures of the operation week and subsequent weeks thereof for the designated period “2015/21 to 2015/35”.

The calculated forecasted weekly-cumulative sales figures of the operation week and subsequent weeks thereof are stored in the first simulation-result table 1100 (“CUMULATIVE TOTAL” in FIG. 11), for example. Also, the calculated forecasted weekly sales figures of the operation week and subsequent weeks thereof are stored in the first simulation-result table 1100 (“SALES” in FIG. 11), for example.

The second sales forecasting unit 904 calculates forecasted weekly sales figures of the n-th week (the operation week) and subsequent weeks thereof for the designated period based on the differences between the weekly consumption speeds (or the change rate) in the record period. Specifically, first, the second sales forecasting unit 904 refers to the weekly attribute record DB 240 and acquires the weekly sales records (and the weekly gross profit records) up to the previous week (the 25th week) of the operation week for the designated period “2015/21 to 2015/35” with regard to the item attribute “A-Brand”, for example.

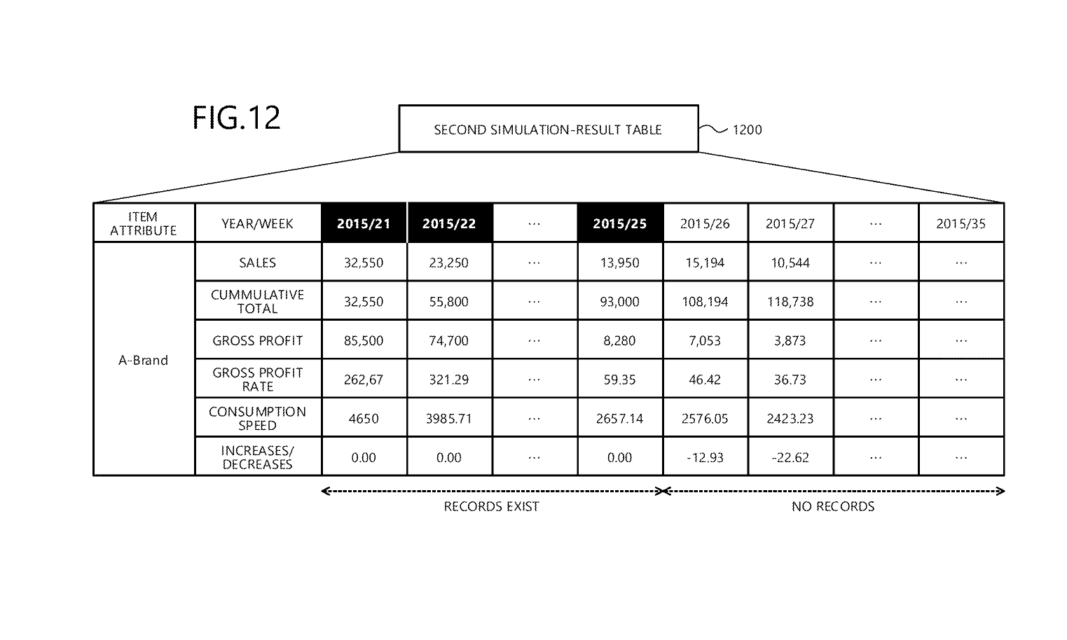

The weekly sales records (and the weekly gross profit records) that have been acquired are stored in a second simulation-result table 1200 as depicted in FIG. 12, for example.

The storage contents of the second simulation-result table 1200 are described here. The second simulation-result table 1200 is implemented by a storage apparatus such as the memory 302 or the disk 305 depicted in FIG. 3, for example.

FIG. 12 is an explanatory diagram depicting an example of storage contents of the second simulation-result table 1200. In FIG. 12, in the second simulation-result table 1200, the weekly sales records and the weekly gross profit records until the 25th week (the previous week of the operation week) for the designated period “2015/21 to 2015/35” with regard to the item attribute “A-Brand” are stored.

Next, the second sales forecasting unit 904 refers to the second simulation-result table 1200 and calculates weekly cumulative sales records up to the previous week (the 25th week) of the operation week for the designated period “2015/21 to 2015/35” with regard to the item attribute “A-Brand”. The calculated weekly cumulative sales records up to the previous week of the operation week are stored in the second simulation-result table 1200 (“CUMULATIVE TOTAL” in FIG. 12), for example.

The second sales forecasting unit 904 then calculates weekly consumption speeds up to the previous week of the n-th week (the operation week) for the designated period. In particular, for example, the second sales forecasting unit 904 may calculate the weekly consumption speeds up to the previous week (the 25th week) of the operation week by using the above equation (2).

Subsequently, the second sales forecasting unit 904 refers to the past record table 1000, for example, and specifies the differences of the weekly consumption speed in the record period “2014/21 to 2014/35”. The second sales forecasting unit 904 then calculates a consumption speed of the operation week for the designated period by adding a difference of the consumption speed of the 26th week (the same week as the operation week) in the record period to the consumption speed of the previous week (the 25th week) of the operation week for the designated period.

The second sales forecasting unit 904 also calculates a consumption speed of the 27th week of the designated period by adding a difference of the consumption speed of the 27th week in the record period to the consumption speed of the operation week (the 26th week) of the designated period. Thereafter, weekly consumption speeds of the 28th week and subsequent weeks thereof in the designated period are calculated in a similar manner.

The second sales forecasting unit 904 then multiplies the weekly consumption speeds of the n-th week (the operation week) and subsequent weeks thereof in the designated period by the elapsed number of days, respectively, to obtain forecasted weekly-cumulative sales figures of the n-th week (the operation week) and subsequent weeks thereof in the designated period. Also, the second sales forecasting unit 904 calculates forecasted weekly sales figures of the n-th week (the operation week) and subsequent weeks thereof in the designated period by subtracting the cumulative sales records of the previous week from the forecasted weekly-cumulative sales figures of the n-th week (the operation week) and subsequent weeks thereof in the designated period.

For example, the forecasted-cumulative sales figure of the 26th week (the operation week) is “108,194 (=consumption speed of the 26th week “2576.05”×elapsed number of days “42”)” (the first place after decimal point is rounded off). Also, the forecasted sales figure of the 26th week (the operation week) is “15,194 (=108,194−93,000)”.

The calculated forecasted weekly-cumulative sales figures of the 26th week (the operation week) and subsequent weeks thereof are stored in the second simulation-result table 1200 (“CUMULATIVE TOTAL” in FIG. 12), for example. Also, the calculated forecasted weekly sales figures of the 26th week (the operation week) and subsequent weeks thereof are stored in the second simulation-result table 1200 (“SALES” in FIG. 12), for example.

The gross-profit forecasting unit 905 may calculate forecasted weekly gross profits of the n-th week (the operation week) and subsequent weeks thereof in the designated period based on the forecasted weekly sales figures of the n-th week (the operation week) and subsequent weeks thereof in the designated period, calculated by the first sales forecasting unit 903 or the second sales forecasting unit 904. The forecasted gross profit is a gross profit that is forecasted.

As an example, a case of calculating the forecasted weekly gross profits based on the forecasted weekly sales figures calculated by the first sales forecasting unit 903 is described. Specifically, first, the gross-profit forecasting unit 905 refers to the past record table 1000 and calculates increases/decreases of the gross profit rate to a reference gross profit rate with regard to the n-th week and subsequent weeks thereof, for example. The reference gross profit rate described here is a gross profit rate of the (n−1)th week in the record period.

For example, it is assumed that the n-th week is “the 26th week” (the operation week is “2015/26”), the reference gross profit rate is a gross profit rate “306.10” of the 25th week in the record period. In this case, the gross-profit forecasting unit 905 subtracts the reference gross profit rate “306.10” from a gross profit rate “293.17” of the 26th week in the record period, to obtain the increase/decrease of the gross profit rate “−12.93” of the 26th week in the record period.

The calculated increases/decreases of the weekly gross profit rate with regard to the n-th week and subsequent weeks thereof in the record period are stored in the first simulation-result table 1100 as increases/decreases of the weekly gross profit rate with regard to the n-th week and subsequent weeks thereof in the designated period (“INCREASE/DECREASE” in FIG. 11), for example.

Next, the gross-profit forecasting unit 905 calculates weekly gross profit rates up to the (n−1)th week in the designated period. Specifically, the gross-profit forecasting unit 905 can calculate weekly gross profit rates up to the 25th week in the designated period “2015/21 to 2015/35” by using the above equation (3), for example.

The calculated weekly gross profit rates until the (n−1)th week are stored in the first simulation-result table 1100 (“GROSS PROFIT RATE” in FIG. 11), for example.

Subsequently, the gross-profit forecasting unit 905 calculates weekly gross profit rates of the n-th week (the operation week) and subsequent weeks thereof in the designated period based on the increases/decreases of the weekly gross profit rate with regard to the n-th week and subsequent weeks thereof in the designated period. For example, the n-th week is assumed to be “the 26th week”. In this case, the gross-profit forecasting unit 905 adds an increase/decrease of the gross profit rate “−12.93” of the 26th week to a gross profit rate “59.35” of the 25th week, to obtain a gross profit rate “46.42” of the 26th week, for example. Gross profit rates of the 27th week and subsequent weeks thereof may be also calculated in a similar manner.

The calculated weekly gross profit rates of the n-th week (the operation week) and subsequent weeks thereof are stored in the first simulation-result table 1100 (“GROSS PROFIT RATE” in FIG. 11), for example.

The gross-profit forecasting unit 905 then calculates forecasted weekly gross profits of the n-th week (the operation week) and subsequent weeks thereof, for example, by multiplying the forecasted weekly sales figures of the n-th week (the operation week) and subsequent weeks thereof by the weekly gross profit rates of the n-th week (the operation week) and subsequent weeks thereof and then dividing the products by 100. For example, a forecasted gross profit of the 26th week (the operation week) is “8,336 (=the forecasted sales figure “17,958” of the 26th week (the operation week)×the gross profit rate “46.42” of the 26th week (the operation week)÷100″ (the first place after decimal point is rounded off).

The calculated forecasted weekly gross profits of the n-th week (the operation week) and subsequent weeks thereof are stored in the first simulation-result table 1100 (“GROSS PROFIT” in FIG. 11), for example.

Upon reception of a selection of displaying the forecasted weekly sales figures for the designated period calculated by the first sales forecasting unit 903, the display control unit 906 performs control of displaying corresponding forecasted weekly sales figures. In this control, the display control unit 906 performs control that displays not only information indicating the weekly growth rates in the record period, used for calculation of the forecasted weekly sales figures for the designated period, but also information indicating (the differences between) the weekly consumption speeds in the record period.

In this example, the information indicating the growth rates may be a graph representing the weekly growth rates in the record period in time series (for example, a line graph or a bar graph), for example, or may be a table representing the weekly growth rates in the record period. The information indicating the consumption speeds may be a graph representing the weekly consumption speeds in the record period in time series, or may be a table representing the weekly consumption speeds (or the differences between the consumption speeds) in the record period.

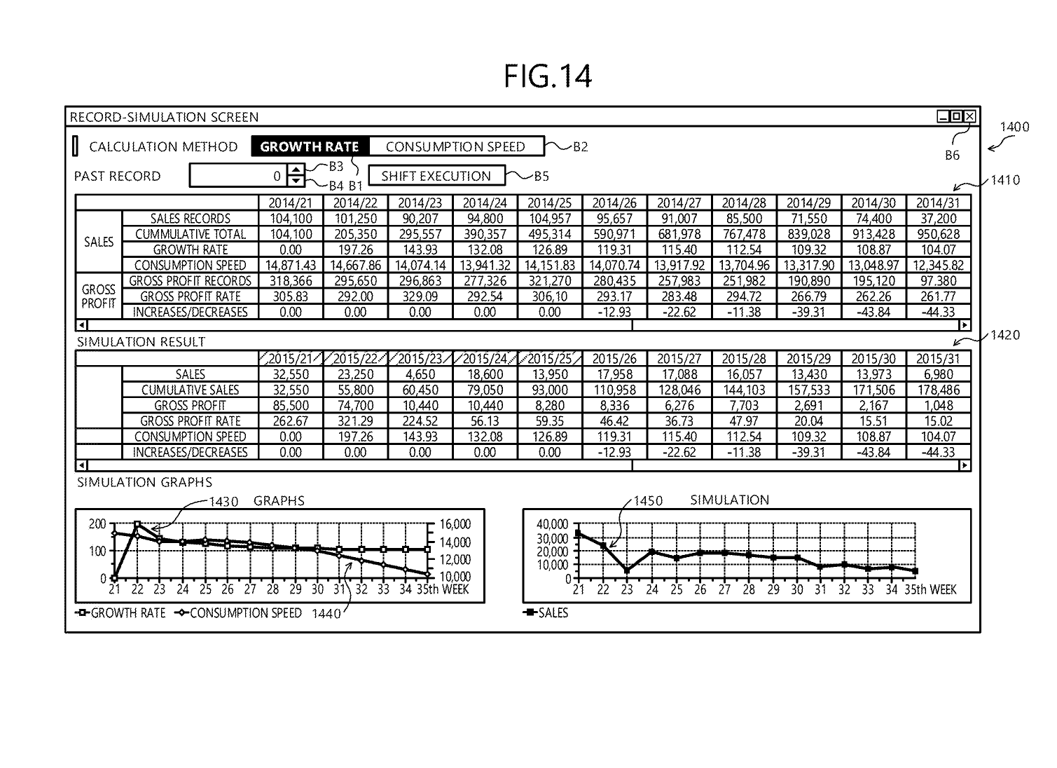

Specifically, in a case where the filter condition includes the calculation method “growth rate”, for example, the display control unit 906 refers to the first simulation-result table 1100 and creates screen information of a record simulation screen 1400 as depicted in FIG. 14 described later. The display control unit 906 then transmits the created screen information of the record simulation screen 1400 to the client apparatus 201. Therefore, the record simulation screen 1400 may be displayed on the display 406 of the client apparatus 201.

Further, upon reception of a selection of displaying the forecasted weekly sales figures for the designated period calculated by the second sales forecasting unit 904, the display control unit 906 performs control of displaying the corresponding forecasted weekly sales figures. In this control, the display control unit 906 performs control that displays not only the information indicating the weekly consumption speeds in the record period, used for calculation of the forecasted weekly sales figures for the designated period, but also information indicating the weekly growth rates in the record period.

Specifically, in a case where the filter condition includes the calculation method “litigation speed”, for example, the display control unit 906 refers to the second simulation-result table 1200 and creates screen information of a record simulation screen 1300 as depicted in FIG. 13 described later. The display control unit 906 then transmits the created screen information of the record simulation screen 1300 to the client apparatus 201. Therefore, the record simulation screen 1300 may be displayed on the display 406 of the client apparatus 201.

The receiving unit 901 receives an input of an instruction to switch the calculation method. The calculation method is a method of calculating the forecasted weekly sales figures of the n-th week (the operation week) and subsequent weeks thereof for the designated period, and is the calculation method “growth rate” or the calculation method “consumption speed”. The switching of the calculation method is instructed in the record simulation screen 1300 or 1400 as depicted in FIG. 13 or 14 described later, for example. Specifically, the receiving unit 901 receives the instruction to switch the calculation method, for example, by receiving the instruction to switch the calculation method from the client apparatus 201.

In addition, upon reception of an instruction to switch to the calculation method “consumption speed” while the forecasted weekly sales figures calculated by the first sales forecasting unit 903 are displayed, the display control unit 906 switches to display of the forecasted weekly sales figures calculated by the second sales forecasting unit 904. During this switching, the display control unit 906 keeps displaying the information indicating the weekly consumption speeds of the record period and the information indicating the weekly growth rates.

Specifically, upon reception of the instruction to switch the calculation method “consumption speed” while the record simulation screen 1400 depicted in FIG. 14 described later is displayed, for example, the display control unit 906 switches to display of the record simulation screen 1300 depicted in FIG. 13 described later.

Furthermore, upon reception of an instruction to switch the calculation method “growth rate” while the forecasted weekly sales figures calculated by the second sales forecasting unit 904 are displayed, the display control unit 906 switches to display of the forecasted weekly sales figures calculated by the first sales forecasting unit 903. During this switching, the display control unit 906 keeps displaying the information indicating the weekly consumption speeds or the record period and the information indicating the weekly growth rates in the record period.

Specifically, upon reception of an instruction to switch the calculation method “growth rate” while the record simulation screen 1300 depicted in FIG. 13 described later is displayed, for example, the display control unit 906 switches to display of the record simulation screen 1400 depicted in FIG. 14 described later.

Further, the receiving unit 901 receives an input of an instruction to change the record period. The instruction to change the record period is an instruction for changing a period as the record period to another period. For example, the record period is initially set to be the same time of the previous year as the designated period and may be shifted according to the change instruction.

However, a changeable width of the record period depends on the display unit. For example, in a case where the display unit is “week”, the record period may be changed on a weekly basis (for example, ±3 weeks). In a case where the display unit is “month”, the record period may be changed on a monthly basis (for example, ±1 month).

For example, the instruction to change the record period is performed in the record simulation screens 1300 and 1400 as depicted in FIG. 13 or 14 described later. Specifically, the receiving unit 901 receives the instruction to change the record period, for example, by receiving the instruction to change the record period from the client apparatus 201.

The record calculating unit 902 changes the record period according to the instruction to change the record period. Specifically, upon reception of an instruction to change the record period by “+1 week”, for example, the record calculating unit 902 changes the record period from “2014/21 to 2014/35” to “2014/22 to 2014/36”.

Further, when changing the record period, the record calculating unit 902 calculates the weekly growth rates in the changed record period. Also, when changing the record period, the record calculating unit 902 calculates the differences of the consumption speed (or the change rate) between two consecutive weeks (partial periods) in the changed record period.

In this case, the first sales forecasting unit 903 calculates the forecasted weekly sales figures of the operation week and subsequent weeks thereof in the designated period based on the weekly growth rates in the changed record period. Also, the second sales forecasting unit 904 calculates the forecasted weekly sales figures of the n-th week (the operation week) and subsequent weeks thereof in the designated period based on the differences of the weekly consumption speed (or the change rates) in the changed record period.

Next, there are described screen examples of the record simulation screen displayed on the display 406 of the client apparatus 201 with reference to FIGS. 13 to 16.

FIG. 13 is an explanatory diagram depicting a screen example of a record simulation screen (part 1). In FIG. 13, the record simulation screen 1300 is an operation screen that displays a simulation result of a sales forecast based on differences between the weekly consumption speeds in the record period “2014/21 to 2014/35”, displayed in a case where the calculation method “consumption speed” is selected.

In the record simulation screen 1300, a past record 1310, a simulation result 1320, and simulation graphs 1330, 1340, and 1350 are displayed. The past record 1310 is a table representing the sales record, the cumulative total (the cumulative sales figure), the growth rate, the consumption speed, the gross profit record, the gross profit rate, and the increase/decrease of the gross profit rate for each week of the record period “2014/21 to 2014/35”.

The simulation result 1320 is a table representing the sales figures, the cumulative sales figures, the gross profit, and the gross profit rate for each week of the designated period “2015/21 to 2015/35”. For the designated period “2015/21 to 2015/35”, the sales figures, the cumulative sales figures, the gross profit, and the gross profit rate for each of the 26th week and subsequent weeks thereof are forecasted values based on the weekly consumption speeds in the record period. Also, in the simulation result 1320, the consumption speed and the increase/decrease of the gross profit rate for each week in the record period “2014/21 to 2014/35” are shown.

The simulation graph 1330 is a line graph representing the weekly growth rates in the record period “2014/21 to 2014/35” in time series. The simulation graph 1340 is a line graph representing the weekly consumption speeds in the record period “2014/21 to 2014/35” in time series. The simulation graph 1350 is a line graph representing the weekly sales figures for the designated period “2015/21 to 2015/35” in time series.

According to the record simulation screen 1300, a user can understand how much sales figures may be forecasted in the 26th week and subsequent weeks thereof of 2015 if this sales trend continues, by referring to the simulation graph 1350 (or the simulation result 1320).

Furthermore, the user can understand that the simulation graph 1350 is a result of the sales forecast based on the differences between the weekly consumption speeds in the record period “2014/21 to 2014/35”. Therefore, the user can determine the suitability of the simulation graph 1350 (the simulation result 1320) after ascertaining the basis for the sales forecast.

Further, the user can recognize the respective contents of “growth rate” and “consumption speed” for each week in the record period “2014/21 to 2014/35”, each of which is the basis for the sales forecast, by referring to the simulation graphs 1330 and 1340. Therefore, it is possible to facilitate determination of the suitability of the simulation graph 1350 (the simulation result 1320) by the user. Further, the user can understand that the user can also confirm another simulation result of a sales forecast based on another basis (the consumption speed).

In the record simulation screen 1300, when a button B1 is clicked, an instruction to switch to the calculation method “growth rate” is input, so that the displayed contents of the display 406 are switched to the record simulation screen 1400 depicted in FIG. 14. Also, when a button B6 is clicked in the record simulation screen 1300, an instruction to terminate the display is input, so that the display of the record simulation screen 1300 may be terminated.

FIG. 14 is an explanatory diagram depicting a screen example of a record simulation screen (part 2). In FIG. 14, the record simulation screen 1400 is an operation screen that displays a simulation result of a sales forecast based on the weekly growth rates in the record period “2014/21 to 2014/35”, displayed in a case where the calculation method “growth rate” is selected.

In the record simulation screen 1400, a past record 1410, a simulation result 1420, and simulation graphs 1430, 1440, and 1450 are displayed. The past record 1410 is a table representing the sales record, the cumulative total (the cumulative sales figure), the growth rate, the consumption speed, the gross profit record, the gross profit rate, and the increase/decrease of the gross profit rate for each week in the record period “2014/21 to 2014/35”.

The simulation result 1420 is a table representing the sales figures, the cumulative sales figures, the gross profit, and the gross profit rate for each week in the designated period “2015/21 to 2015/35”. For the designated period “2015/21 to 2015/35”, the sales figures, the cumulative sales figures, the gross profit, and the gross profit rate for each of the 26th week and subsequent weeks thereof are forecasted values based on the growth rate for each week in the record period. Also, the simulation result 1420 indicates the consumption speed and the increase/decrease of the gross profit rate for each week in the record period “2014/21 to 2014/35”.

The simulation graph 1430 is a line graph representing weekly growth rates in the record period “2014/21 to 2014/35” in time series. The simulation graph 1440 is a line graph representing the weekly consumption speeds in the record period “2014/21 to 2014/35” in time series. The simulation graph 1450 is a line graph representing the weekly sales figures for the designated period “2015/21 to 2015/35” in time series.

According to the record simulation screen 1400, a user can understand how much sales figures may be forecasted in the 26th week and subsequent weeks thereof of 2015 if the current sales trend continues, by referring to the simulation graph 1450 (or the simulation result 1420).

Furthermore, the user can understand that the simulation graph 1450 is a result of the sales forecast based on the weekly growth rates in the record period “2014/21 to 2014/35”. Therefore, the user can determine the suitability of the simulation graph 1450 (the simulation result 1410) after ascertaining the basis for the sales forecast.

Further, the user can recognize the respective contents of “growth rate” and “consumption speed” for each week in the record period “2014/21 to 2014/35”, each of which is the basis for the sales forecast, by referring to the simulation graphs 1430 and 1440. Therefore, it is possible to facilitate determination of the suitability of the simulation graph 1450 (the simulation result 1420) by the user.

In the record simulation screen 1400, when a button B2 is clicked, an instruction to switch to the calculation method “consumption speed” is input, so that the displayed contents of the display 406 are switched to the record simulation screen 1300 depicted in FIG. 13. Also, when the button B6 is clicked in the record simulation screen 1400, an instruction to terminate the display is input, so that the display of the record simulation screen 1400 may be terminated.

In the record simulation screen 1400, when a button B3 or B4 is clicked, the record period may be changed. For example, when the button B3 is clicked once, the record period may be changed by “+1 week”. Also, when the button B4 is clicked once, the record period may be changed by “−1 week”. Further, when a button B5 is clicked in the record simulation screen 1400, an instruction to change the record period may be input.

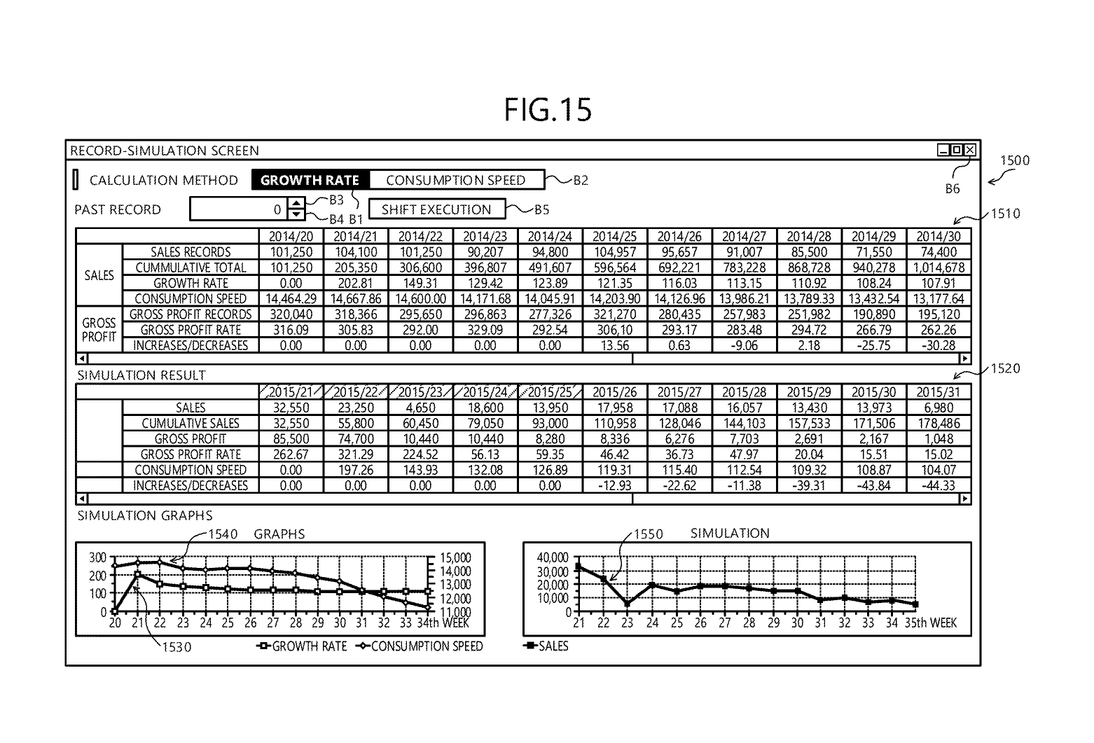

For example, in a state where the button B4 has been clicked once, when the button B5 is clicked, an instruction to change the record period by “−1 week” is input. As a result, the displayed contents of the display 406 are switched to a record simulation screen 1500 depicted in FIG. 15 described later.

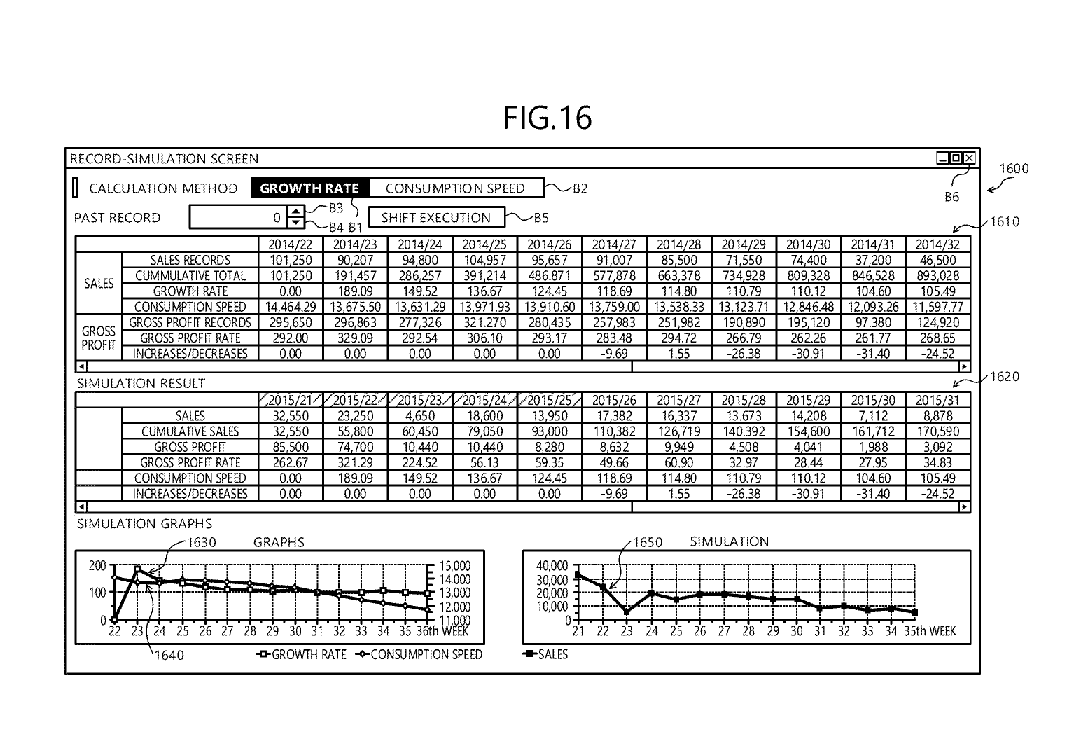

In a state where the button B3 has been clicked once, when the button B5 is clicked, for example, an instruction to change the record period by “+1 week” is input. As a result, the displayed contents of the display 406 are switched to a record simulation screen 1600 depicted in FIG. 16 described later.

FIG. 15 is an explanatory diagram depicting a screen example of a record simulation screen (part 3). In FIG. 15, the record simulation screen 1500 is an operation screen that displays the simulation result of the sales forecast based on the weekly growth rates in the changed record period “2014/20 to 2014/34”.

In the record simulation screen 1500, a past record 1510, a simulation result 1520, and simulation graphs 1530, 1540, and 1550 are displayed. The past record 1510 is a table representing the sales record, the cumulative total (the cumulative sales figure), the growth rate, the consumption speed, the gross profit record, the gross profit rate, and the increase/decrease of the gross profit rate for each week in the changed record period “2014/20 to 2014/34”.

The simulation result 1520 is a table representing the sales figures, the cumulative sales figures, the gross profit, and the gross profit rate for each week in the designated period “2015/21 to 2015/35”. For the designated period “2015/21 to 2015/35”, the sales figures, the cumulative sales figures, the gross profit, and the gross profit rate for each of the 26th week and subsequent weeks thereof are forecasted values based on the weekly growth rates in the record period. Also, the simulation result 1520 indicates the weekly consumption speeds and the increases/decreases of the weekly gross profit rate in the changed record period “2014/20 to 2014/34”.

The simulation graph 1530 is a line graph representing the weekly growth rates in the changed record period “2014/20 to 2014/34” in time series. The simulation graph 1540 is a line graph representing the weekly consumption speeds in the changed record period “2014/20 to 2014/34” in time series. The simulation graph 1550 is a line graph representing the weekly sales figures in the designated period “2015/21 to 2015/35” in time series.

According to the record simulation screen 1500, it is possible to confirm the simulation graph 1550 (or the simulation result 1520) obtained by the sales forecast based on the weekly growth rates in the changed record period “2014/20 to 2014/34”. Due to this configuration, in a case where a receiving time of an item of the item attribute “A-Brand” of 2015 is later than the previous year by one week, for example, it is possible to make the sales forecast while the record period is shifted by “−1 week”.

FIG. 16 is an explanatory diagram depicting a screen example of a record simulation screen (part 4). In FIG. 16, the record simulation screen 1600 is an operation screen that displays the simulation result of the sales forecast based on the weekly growth rates in the changed record period “2014/22 to 2014/36”.

In the record simulation screen 1600, a past record 1610, a simulation result 1620, and simulation graphs 1630, 1640, and 1650 are displayed. The past record 1610 is a table representing the sales record, the cumulative total (the cumulative sales figure), the growth rate, the consumption speed, the gross profit record, the gross profit rate, and the increase/decrease of the gross profit rate for each week in the changed record period “2014/22 to 2014/36”.

The simulation result 1620 is a table representing the sales figures, the cumulative sales figures, the gross profit, and the gross profit rate for each week in the designated period “2015/21 to 2015/35”. For the designated period “2015/21 to 2015/35”, the sales figures, the cumulative sales figures, the gross profit, and the gross profit rate for each of the 26th week and subsequent weeks thereof are forecasted values based on the weekly growth rates in the record period. Also, the simulation result 1620 indicates the weekly growth rates and the increases/decreases of the weekly gross profit rate in the changed record period “2014/22 to 2014/36”.

The simulation graph 1630 is a line graph representing the weekly growth rates in the changed record period “2014/22 to 2014/36” in time series. The simulation graph 1640 is a line graph representing the weekly consumption speeds in the changed record period “2014/22 to 2014/36” in time series. The simulation graph 1650 is a line graph representing the weekly sales figures in the designated period “2015/21 to 2015/35” in time series.

According to the record simulation screen 1600, it is possible to confirm the simulation graph 1650 (or the simulation result 1620) obtained by the sales forecast based on the weekly growth rates in the changed record period “2014/22 to 2014/36”. Due to this configuration, in a case where the receiving time of the item of the item attribute “A-Brand” of 2015 is earlier than the previous year by one week, for example, the sales forecast may be made while the record period is shifted by “+1 week”.

Next, a procedure of a sales-forecast displaying process of the sales forecast display apparatus 100 is described.

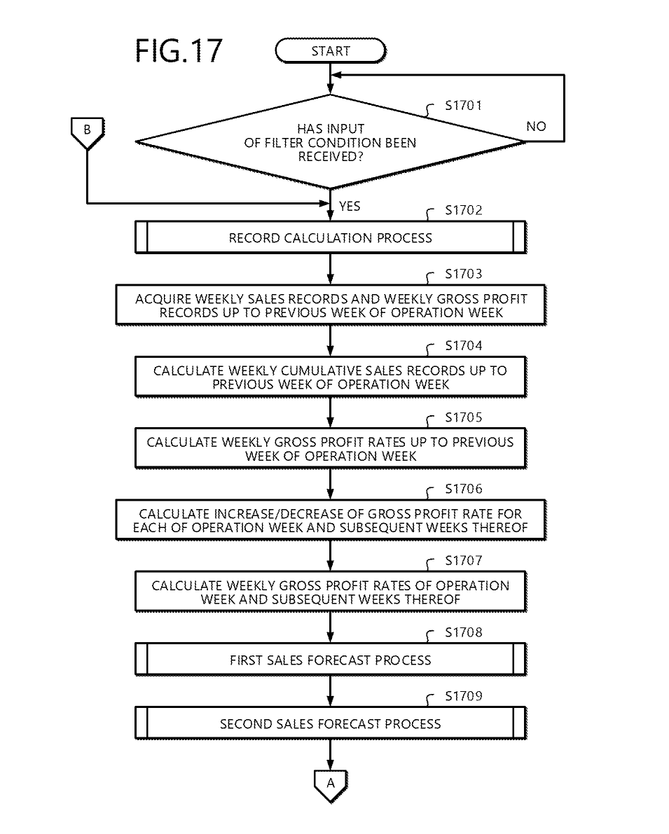

FIGS. 17 and 18 are flowcharts depicting procedures of the sales-forecast displaying process of the sales forecast display apparatus 100. In the flowchart of FIG. 17, the sales forecast display apparatus 100 determines whether an input of a filter condition has been received (step S1701). At this step, the sales forecast display apparatus 100 waits for reception of the input of a filter condition (step S1701: NO).

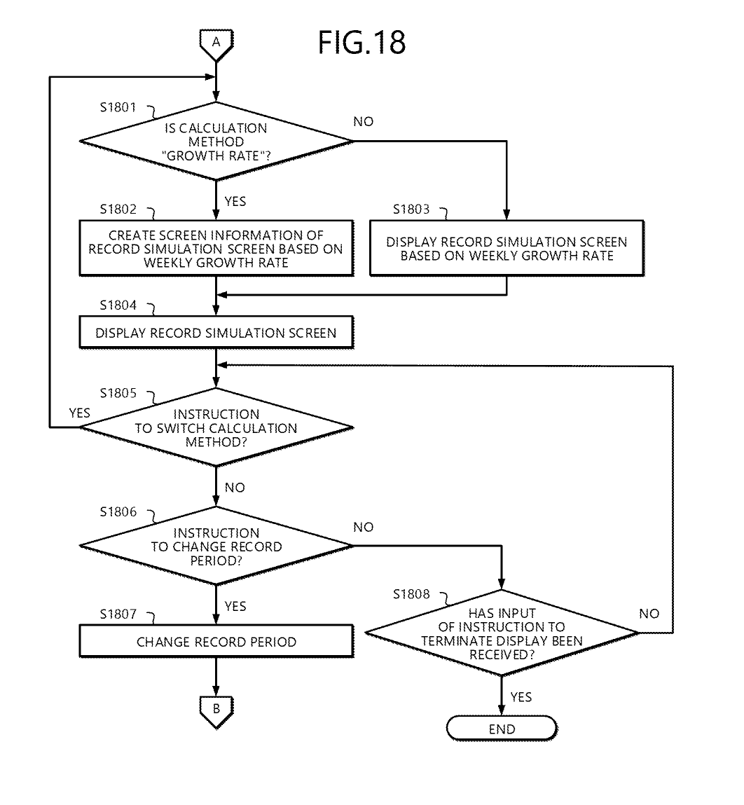

Upon reception of the input of the filter condition (step S1701: YES), the sales forecast display apparatus 100 performs a record calculation process (step S1702). Specific processing procedures of the record calculation process are described later with reference to FIG. 19.

The sales forecast display apparatus 100 refers to the weekly attribute record DB 240 and acquires weekly sales records and weekly gross profit records up to a previous week (the (n−1)th week) of an operation week in a designated period with regard to an item attribute specified from the filter condition (step S1703). The sales forecast display apparatus 100 calculates weekly cumulative sales records up to the previous week of the operation week (step S1704).

Next, the sales forecast display apparatus 100 calculates weekly gross profit rates up to the previous week of the operation week (step S1705). The sales forecast display apparatus 100 refers to the past record table 1000 and calculates an increase/decrease of the gross profit rate for each of the n-th week and subsequent weeks thereof with respect to a reference gross profit rate (step S1706).

The sales forecast display apparatus 100 calculates weekly gross profit rates of the operation week (the n-th week) and subsequent weeks thereof in the designated period based on the increases/decreases of the weekly gross profit rate of the n-th week and subsequent weeks thereof (step S1707). The processing results at steps S1703 to S1707 are stored in the first simulation-result table 1100 and the second simulation-result table 1200, for example.

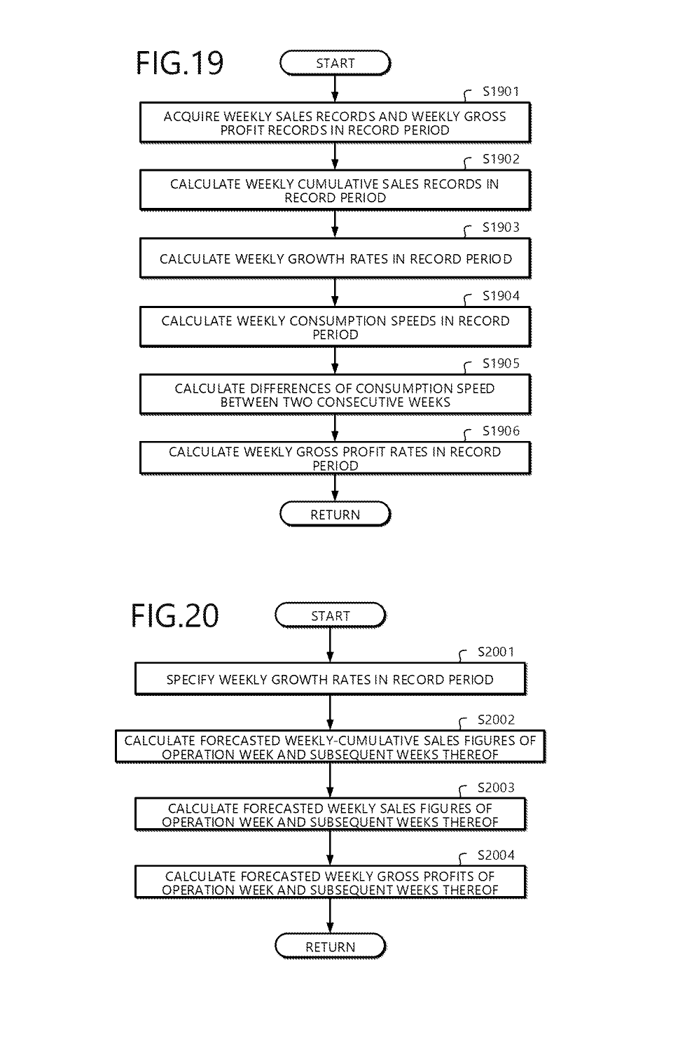

Subsequently, the sales forecast display apparatus 100 performs a first sales forecast process (step S1708). Specific processing procedures of the first sales forecast process are described later with reference to FIG. 20.

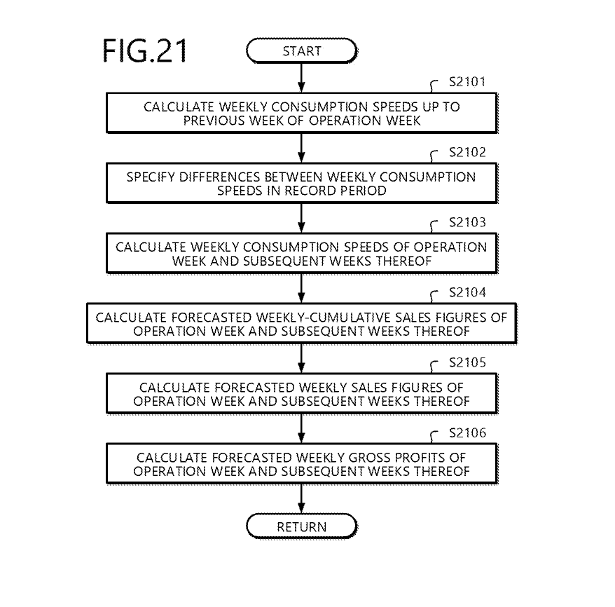

The sales forecast display apparatus 100 performs a second sales forecast process (step S1709), and proceeds to step S1801 depicted in FIG. 18. Specific processing procedures of the second sales forecast process are described later with reference to FIG. 21.

In the flowchart of FIG. 18, the sales forecast display apparatus 100 determines whether a calculation method specified from the filter condition is “growth rate” (step S1801).

In a case where the calculation method is “growth rate” (step S1801: YES), the sales forecast display apparatus 100 refers to the first simulation-result table 1100, creates screen information of a record simulation screen (step S1802), and proceeds to step S1804. This record simulation screen is a screen that displays a simulation result of a sales forecast based on weekly growth rates in a record period.

Meanwhile, in a case where the calculation method is “consumption speed” (step S1801: NO), the sales forecast display apparatus 100 refers to the second simulation-result table 1200, and creates screen information of a record simulation screen (step S1803). This record simulation screen is a screen that displays a simulation result of a sales forecast based on differences between weekly consumption speeds in the record period.

The sales forecast display apparatus 100 then transmits the created screen information of the record simulation screen to the client apparatus 201, so that the record simulation screen is displayed on the client apparatus 201 (step S1804).

Next, the sales forecast display apparatus 100 determines whether it has received an input of an instruction to switch the calculation method (step S1805). In a case where the sales forecast display apparatus 100 has received the input of the instruction to switch the calculation method (step S1805: YES), the sales forecast display apparatus 100 proceeds to step S1801.

Meanwhile, in a case where the sales forecast display apparatus 100 has not received the input of the instruction to switch the calculation method (step S1805: NO), the sales forecast display apparatus 100 determines whether it has received an input of an instruction to change the record period (step S1806). In a case where the sales forecast display apparatus 100 has received the input of the instruction to change the record period (step S1806: YES), the sales forecast display apparatus 100 changes the record period (step S1807) and proceeds to step S1702 depicted in FIG. 17.

Meanwhile, in a case where the sales forecast display apparatus 100 has not received the input of the instruction to change the record period (step S1806: NO), the sales forecast display apparatus 100 determines whether an input of an instruction to terminate display has been received (step S1808). In a case where the sales forecast display apparatus 100 has not received the input of the instruction to terminate the display (step S1808: NO), the sales forecast display apparatus 100 returns to step S1805.

On the other hand, in a case where the sales forecast display apparatus 100 has received the input of the instruction to terminate the display (step S1808: YES), the sales forecast display apparatus 100 terminates a series of processes by this flowchart.

Consequent to these steps, it is possible to display the record simulation screen according to the calculation method that may be switched by an operation input by a user. Also, by the operation input by the user, it is possible to change the record period and make a sales forecast and a gross-profit forecast again.

Next, a specific processing procedure of the record calculation process at step S1702 depicted in FIG. 17 is described.

FIG. 19 is a flowchart depicting an example of a specific processing procedure of the record calculation process. In the flowchart of FIG. 19, first, the sales forecast display apparatus 100 refers to the weekly attribute record DB 240 and acquires the weekly sales records and the weekly gross profit records in the record period with regard to a record-reference attribute specified from the filter condition (step S1901).

The sales forecast display apparatus 100 calculates the weekly cumulative sales records in the record period (step S1902). The sales forecast display apparatus 100 calculates the weekly growth rates in the record period based on the weekly cumulative sales records in the record period (step S1903).

Next, the sales forecast display apparatus 100 calculates the weekly consumption speeds in the record period based on the weekly cumulative sales records in the record period (step S1904). The sales forecast display apparatus 100 then calculates differences of the consumption speed between two consecutive weeks in the record period (step S1905).

Subsequently, the sales forecast display apparatus 100 calculates the weekly gross profit rates in the record period (step S1906), and returns to the step at which the record calculation process is called up. The processing results at steps S1901 to S1906 are stored in the past record table 1000, for example.

Consequent to these steps, it is possible to obtain the weekly growth rates and the differences between the weekly consumption speeds in the record period with regard to the record-reference attribute, which are used for the sales forecast. Also, it is possible to obtain the weekly gross profit rates in the record period with regard to the record-reference attribute, which are used for the gross-profit forecast.

Next, a specific processing procedure of the first sales forecast process at step S1708 depicted in FIG. 17 is described.

FIG. 20 is a flowchart depicting an example of a specific processing procedure of the first sales forecast process. In the flowchart of FIG. 20, first, the sales forecast display apparatus 100 refers to the past record table 1000 and specifies the weekly growth rates in the record period (step S2001).

Next, the sales forecast display apparatus 100 calculates forecasted weekly-cumulative sales figures of the operation week and subsequent weeks thereof in the designated period based on the weekly growth rates in the record period (step S2002). The sales forecast display apparatus 100 then calculates forecasted weekly sales figures of the operation week and subsequent weeks thereof in the designated period (step S2003).

Subsequently, the sales forecast display apparatus 100 calculates forecasted weekly gross profits of the operation week and subsequent weeks thereof in the designated period based on the forecasted weekly sales figures of the operation week and subsequent weeks thereof in the designated period (step S2004), and returns to the step at which the first sales forecast process is called up. The processing results at steps S2001 to S2004 are stored in the first simulation-result table 1100, for example.

Due to these steps, it is possible to calculate the forecasted weekly sales, the forecasted weekly-cumulative sales figures, and the weekly gross profits of the operation week and subsequent weeks thereof in the designated period based on the weekly growth rates in the record period.

Next, a specific processing procedure of the second sales forecast process at step S1709 depicted in FIG. 17 is described.

FIG. 21 is a flowchart depicting an example of a specific processing procedure of the second sales forecast process. In the flowchart of FIG. 21, first, the sales forecast display apparatus 100 calculates the weekly consumption speeds up to the previous week of the operation week in the designated period (step S2101).

Next, the sales forecast display apparatus 100 refers to the past record table 1000 and specifies the differences between the weekly consumption speeds in the record period (step S2102). The sales forecast display apparatus 100 then calculates weekly consumption speeds of the operation week and subsequent weeks thereof in the designated period based on the differences between the weekly consumption speeds in the record period (step S2103).

Subsequently, the sales forecast display apparatus 100 calculates the forecasted weekly-cumulative sales figures of the operation week and subsequent weeks thereof in the designated period by multiplying the weekly consumption speeds of the operation week and subsequent weeks thereof in the designated period by the elapsed number of days, respectively (step S2104). The sales forecast display apparatus 100 then calculates the forecasted weekly sales figures of the operation week and subsequent weeks thereof in the designated period (step S2105).

Next, the sales forecast display apparatus 100 calculates the forecasted weekly gross profits of the operation week and subsequent weeks thereof in the designated period based on the forecasted weekly sales figures of the operation week and subsequent weeks thereof in the designated period (step S2106), and returns to the step at which the second sales forecast process is called up. The processing results at steps S2101 and S2103 to S2106 are stored in the second simulation-result table 1200, for example.

Due to these steps, it is possible to calculate the forecasted weekly sales figures, the forecasted weekly-cumulative sales figures, and the forecasted weekly gross profits of the operation week and subsequent weeks thereof in the designated period based on the differences between the weekly consumption speeds in the record period.

As described above, according to the sales forecast display apparatus 100 according the embodiment, an input of a filter condition may be received. Therefore, a user can designate an item attribute and a period for which a sales forecast is performed, and a record-reference attribute used for the sales forecast, for example. Also, the user can select whether to display a simulation result of a sales forecast using a calculation method “growth rate” or a simulation result of a sales forecast using a calculation method “consumption speed”.

According to the sales forecast display apparatus 100, in a case where the calculation method “growth rate” is selected, it is possible to display not only information indicating growth rates but also information indicating consumption speeds when the simulation result of the sales forecast based on weekly growth rates in a record period is displayed. Also, according to the sales forecast display apparatus 100, in a case where the calculation method “consumption speed” is selected, it is possible to display not only information indicating (differences between) the consumption speeds but also the information indicating the growth rates when the simulation result of the sales forecast based on the differences between the weekly consumption speeds in the record period is displayed. The information indicating the growth rates is a graph or a table representing a time-series change of the weekly growth rates in the record period, for example. The information indicating the consumption speeds is a graph or a table representing a time-series change of the weekly consumption speeds in the record period, for example.

Due to this configuration, it is possible to allow the user to recognize the respective contents of “growth rate” and “consumption speed” for each week in the record period, which are used as the bases for the sales forecast, when the user confirms the simulation result of the sales forecast, so that determination of the suitability of the simulation result may be facilitated. For example, in a case where the time-series change of the growth rates is not suitable for an item as an object of the sales forecast, it may be determined that the simulation result based on the growth rates is not suitable. Further, in a case where it may be said that the time-series change of the consumption speeds matches the item as the object of the sales forecast better than the growth rates, it may be determined that the simulation result based on the differences between the consumption speeds is more suitable.

Furthermore, according to the sales forecast display apparatus 100, when an instruction to switch to the calculation method “consumption speed” has been received while the simulation result of the sales forecast based on the weekly growth rates in the record period is displayed, it is possible to switch to display of the simulation result of the sales forecast based on the differences between the weekly consumption speeds in the record period. At this time, according to the sales forecast display apparatus 100, it is possible to keep displaying the information indicating the growth rates and the information indicating the consumption speeds.

Further, according to the sales forecast display apparatus 100, when an instruction to switch to the calculation method “growth rate” has been received while the simulation result of the sales forecast based on the differences between the weekly consumption speeds in the record period is displayed, it is possible to switch to display of the simulation result of the sales forecast based on the weekly growth rates in the record period. At this time, according to the sales forecast display apparatus 100, it is possible to keep displaying the information indicating the consumption speeds and the information indicating the growth rates.

Due to this configuration, also when the simulation result is confirmed after switching of the calculation method, it is possible to enable the user to recognize the respective contents of “growth rate” and “consumption speed” for each week in the record period, which are the bases for the sales forecast, and so that determination of the suitability of the simulation result may be facilitated. Further, after confirming the simulation results respectively using “growth rate” and “consumption speed” as the bases, the user is allowed to determine which one of the simulation results is employed. Furthermore, in a case where the user has determined that both of the simulation results are not suitable, it is possible to change the record-reference attribute, for example, to make a sales forecast again.

According to the sales forecast display apparatus 100, it is possible to change the record period in response to reception of an input of an instruction to change the record period. Further, according to the sales forecast display apparatus 100, based on sales records in the changed record period, it is possible to display the simulation result of the sales forecast with regard to a designated period. Consequent to this configuration, in a case where a receiving time (a selling time) of an item is different from the previous year, for example, the record period may be changed, so that improvement of accuracy of the sales forecast may be achieved.

According to the sales forecast display apparatus 100, when the simulation result of the sales forecast based on the weekly growth rates in the record period is displayed, it is possible to display a simulation result of a gross-profit forecast based on the simulation result in question. Also, according to the sales forecast display apparatus 100, when the simulation result of the sales forecast based on the differences between the weekly consumption speeds in the record period is displayed, it is possible to display a simulation result of a gross-profit forecast based on the simulation result in question. Due to this configuration, it is possible to make a forecast while taking forecasted weekly gross profits in the designated period into consideration.

As described above, according to the sales forecast display apparatus 100, it is possible to facilitate determination of the suitability of the simulation result of the sales forecast based on the sales records and to support accurate forecasting of sales figures conducted by a user. Therefore, when an annually determined budget or earning forecast is re-evaluated in a shorter span such as semiannually or quarterly, it is easy to make a forecast, so that the user can flexibly respond to a rapidly changing business environment.

The sales forecast display method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

However, according to the conventional techniques above, for example, when selling numbers in the future are forecasted, it is difficult to accurately forecast sales figures. For example, it is conceivable that, by making a sales forecast with a certain method based on sales records and presenting the result thereof, accurate forecasting of sales figures conducted by a user is supported. However, it is difficult for the user to determine the suitability of the result obtained by the sales forecast.

According to an aspect of the present invention, accurate forecasting of sales figures may be supported.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A sales forecast display method comprising:
receiving selection of whether to display a simulation result of a sales forecast based on a first trend related to sales calculated based on sales records or a simulation result of a sales forecast based on a second trend related to sales calculated based on the sales records; and
displaying, by a computer, not only information indicating the first trend used for calculation of the simulation result of the sales forecast based on the first trend but also information indicating the second trend, when selection of displaying the simulation result of the sales forecast based on the first trend is received.

2. The sales forecast display method according to claim 1, wherein
the displaying includes displaying the simulation result of the sales forecast based on the first trend when the selection of displaying the simulation result of the sales forecast based on the first trend is received, and
the sales forecast display method further comprising
switching, by the computer, display of the simulation result of the sales forecast based on the first trend to display of the simulation result of the sales forecast based on the second trend while maintaining display of the information indicating the first trend and the information indicating the second trend, when selection of displaying the simulation result of the sales forecast based on the second trend is received while the simulation result of the sales forecast based on the first trend is displayed.

3. The sales forecast display method according to claim 1, wherein
the first trend is a change rate of sales figures between two consecutive periods among a plurality of periods included in a predetermined period in past, and
the second trend is a difference of an average value of sales figures from a first one of the plurality of periods to each of the plurality of periods between two consecutive periods among the plurality of periods included in the predetermined period in the past.

4. The sales forecast display method according to claim 3, further comprising
displaying, by the computer when the simulation result of the sales forecast based on the first trend is displayed, a simulation result of a gross-profit forecast based on the simulation result of the sales forecast based on the first trend; and
displaying, by the computer when the simulation result of the sales forecast based on the second trend is displayed, a simulation result of a gross-profit forecast based on the simulation result of the sales forecast based on the second trend.

5. The sales forecast display method according to claim 3, wherein
the first trend is a change rate of cumulative sales figures between the two consecutive periods, the cumulative sales figures being obtained by accumulating sales figures from the first one of the plurality of periods to each of the plurality of periods, and
the second trend is a difference of an average value of daily sales figures between the two consecutive periods, each of the daily sales figures being obtained by dividing, by an elapsed number of days, cumulative sales figures obtained by accumulating sales figures from the first one of the plurality of periods to each of the plurality of periods.

6. The sales forecast display method according to claim 4, wherein the gross-profit forecast is a gross-profit forecast based on a difference of a gross profit rate between a certain period among the plurality of periods and the each of the plurality of periods.

7. A sales forecast display method of displaying a simulation result of a sales forecast based on sales records, the method comprising:
displaying the simulation result of the sales forecast with regard to a first period corresponding to a second period, based on a value indicating a sales trend for each partial period included in the second period, the value being calculated based on past sales records in the second period;
receiving an instruction to shift the first second to a third period; and
displaying, by a computer in response to the instruction, the simulation result of the sales forecast with regard to the first period based on a value indicating a sales trend with regard to each partial period in the third period.

8. A sales forecast display apparatus comprising:
a processor configured to:
receive selection of whether to display a simulation result of a sales forecast based on a first trend related to sales calculated based on sales records or a simulation result of a sales forecast based on a second trend related to sales calculated based on the sales records; and
display not only information indicating the first trend used for calculation of the simulation result of the sales forecast based on the first trend but also information indicating the second trend, when selection of displaying the simulation result of the sales forecast based on the first trend is received.

9. A sales forecast display apparatus comprising:
a processor configured to:
display a simulation result of a sales forecast with regard to a first period corresponding to a second period, based on a value indicating a sales trend for each partial period included in a past second period calculated based on sales records in the second period;
receive an instruction to shift the second period to a third period; and
display in response to the instruction, the simulation result of the sales forecast with regard to the first period based on a value indicating a sales trend with regard to each partial period in the third period.

10. A non-transitory, computer-readable recording medium storing therein a sales forecast display program that causes a computer to execute a process comprising:
receiving selection of whether to display a simulation result of a sales forecast based on a first trend related to sales calculated based on sales records or a simulation result of a sales forecast based on a second trend related to sales calculated based on the sales records; and
displaying not only information indicating the first trend used for calculation of the simulation result of the sales forecast based on the first trend but also information indicating the second trend, when selection of displaying the simulation result of the sales forecast based on the first trend is received.

11. A non-transitory, computer-readable recording medium storing therein a sales forecast display program that causes a computer to display a simulation result of a sales forecast based on sales records and execute a process comprising:
displaying the simulation result of the sales forecast with regard to a first period corresponding to a second period, based on a value indicating a sales trend for each partial period included in a past second period calculated based on sales records in the second period;
receiving an instruction to shift the second period to a third period; and
displaying in response to the instruction, the simulation result of the sales forecast with regard to the first period based on a value indicating a sales trend with regard to each partial period in the third period.
